(19) United States
(12) Patent Application Publication
(10) Pub. No.: US 2005/0090399 A1
(43) Pub. Date: Apr. 28, 2005

(54) Phenyl substituted heterocyclic compounds useful as herbicides

(76) Inventors: Adrian Alberto Friedmann, Bracknell (GB); Andre Stoller, Basel (CH); Sebastian Wendeborn, Basel (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/502,564

(22) PCT Filed: Jan. 21, 2003
(86) PCT No.: PCT/EP03/00555

(30) Foreign Application Priority Data
Jan. 22, 2002 (CH) 0119/02

(51) Int. Cl. A01N 43/56; A01N 43/10; A01N 43/32

(52) U.S. Cl. 504/282; 504/289; 504/293; 548/366.4; 548/544; 549/62; 549/313

(57) ABSTRACT

Compounds of formula (I) wherein the substituents are as defined in claim 1, and also agronomically acceptable salts, isomers and enantiomers of such compounds are suitable for use as herbicides.

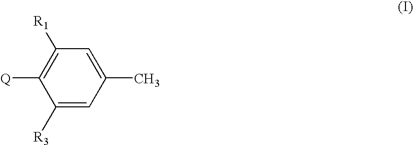

The present invention relates to novel, herbicidally active heterocyclic compounds substituted by a phenyl group, to processes for their preparation, to compositions comprising those compounds, and to their use in controlling weeds, especially in crops of useful plants, or in inhibiting plant growth.

3-Hydroxy-4-aryl-5-oxo-pyrazoline derivatives having herbicidal action are described, for example, in WO 01/17972.

Novel heterocyclic compounds that are substituted by a phenyl group and that have herbicidal and growth-inhibiting properties have now been found.

The present invention accordingly relates to compounds of formula I 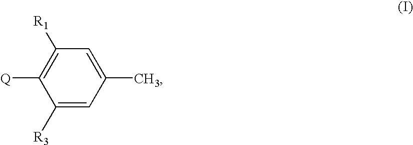
wherein
R₁ and R₃ are each independently of the other ethyl, haloethyl, ethynyl, C₁-C₂alkoxy, C₁-C₂haloalkoxy, C₁-C₂alkylcarbonyl, C₁-C₂hydroxyalkyl or C₁-C₂alkoxycarbonyl;
Q is a group 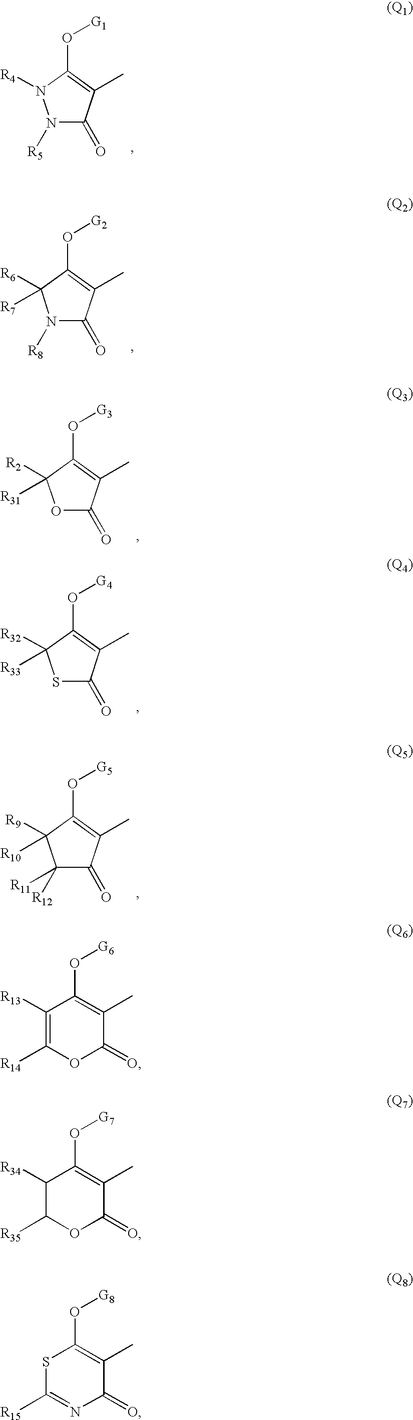 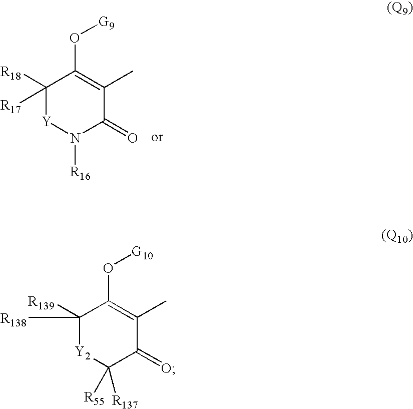
R₄ and R₅ are each independently of the other C₁-C₁₀alkyl, C₂-C₁₀alkenyl, C₂-C₁₀alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀-alkylthioalkyl, C₂-C₁₀alkylsulfinylalkyl, C₂-C₁₀alkylsulfonylalkyl, C₂-C₁₀alkylcarbonylalkyl, C₂-C₁₀-N-alkoxy-iminoalkyl, C₂-C₁₀alkoxycarbonylalkyl, C₁-C₁₀aminoalkyl, C₃-C₁₀dialkylaminoalkyl, C₂-C₁₀alkylaminoalkyl, C₁-C₁₀cyanoalkyl, C₄-C₁₀cycloalkylalkyl, C₁-C₁₀phenylalkyl, C₁-C₁₀heteroarylalkyl, C₁-C₁₀phenoxyalkyl, C₁-C₁₀heteroaryloxyalkyl, C₁-C₁₀alkylideneaminooxyalkyl, C₁-C₁₀nitroalkyl, C₁-C₁₀trialkylsilylalkyl, C₂-C₁₀alkylaminocarbonylalkyl, C₂-C₁₀dialkylaminocarbonylalkyl, C₂-C₁₀alkylaminocarbonyloxyalkyl, C₃-C₁₀dialkylaminocarbonyloxyalkyl, C₂-C₁₀alkoxycarbonylaminoalkyl, C₁-C₁₀-N-alkoxycarbonyl-N-alkylamino-alkyl, C₁-C₁₀cycloalkyl, aryl or heteroaryl; or
R₄ and R₅, together with the atoms to which they are bonded, form a 5 to 7-membered ring which may contain one or two hetero atoms selected from nitrogen, oxygen and sulfur and which may additionally contain a fused or spiro-linked alkylene or alkenylene chain consisting of from 2 to 6 carbon atoms which may in turn contain one or two hetero atoms selected from oxygen and sulfur, it being possible for that ring to be substituted by phenyl or by benzyl each of which may in turn be substituted by halogen, C₁-C₆alkyl, C₁-C₆haloalkyl, C₃-C₆cycloalkyl, hydroxy, C₁-C₆alkoxy, C₁-C₆alkoxy-C₁-C₆alkoxy, C₁-C₆haloalkoxy or by nitro;
R₂, R₆ and R₃₂ are each independently of the others C₁-C₁₀alkyl, C₂-C₁₀alkenyl, C₂-C₁₀alkynyl, C₁-C₁₀haloalkyl, C₂₋₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C₂-C₁₀alkylsulfonylalkyl, C₂-C₁₀alkylcarbonylalkyl, C₃-C₁₀-cycloalkyl, aryl or heteroaryl;
R₇, R₃, and R₃₃ are each independently of the others hydrogen, C₁-C₁₀alkyl, C₂-C₁₀alkenyl, C₂-C₁₀alkynyl or C₂-C₁₀alkoxyalkyl;
R₈ is hydrogen, C₁-C₁₀alkyl, C₁-C₁₀haloalkyl, C₂-C₁₀alkoxyalkyl, C₃-C₁₀alkenyloxyalkyl, C₃-C₁₀-alkynyloxyalkyl, C₂-C₁₀alkylthioalkyl, C₂-C₁₀alkylsulfinylalkyl, C₂-C₁₀alkylsulfonylalkyl, C₃-C₁₀-cycloalkyl, aryl or heteroaryl; or
R₆ and R₇, or R₂ and R₃₁, or R₃₂ and R₃₃, together with the atom to which they are bonded, form a saturated, 3- to 7-membered ring which may contain one or two hetero atoms selected from nitrogen, oxygen and sulfur; or R₆ and R₈, together with the atoms to which they are bonded, form a 5- to 7-membered ring which may contain one or two hetero atoms selected from nitrogen, oxygen and sulfur;
R₉, R₁₀, R₁₁, and R₁₂ are each independently of the others C₁-C₁₀alkyl, C₂-C₁₀alkenyl, C₂-C₁₀-alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C₂-C₁₀alkylsulfonylalkyl, C₂-C₁₀alkylcarbonylalkyl, C₃-C₁₀cycloalkyl, aryl or heteroaryl; or
R₉ and R₁₁, or R₉ and R₁₀, together with the atoms to which they are bonded, form a 5- to 7-membered ring which may contain one or two hetero atoms selected from nitrogen, oxygen and sulfur;
R₁₃, R₁₄, R₃₄ and R₃₅ are each independently of the others C₁-C₁₀alkyl, C₂-C₁₀alkenyl, C₂-C₁₀-alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C2-C₁₀alkylsulfonylalkyl, C₂-C₁₀alkylcarbonylalkyl, C₃-C₁₀cycloalkyl, aryl or heteroaryl; or
R₁₃ and R₁₄, or R₃₄ and R₃₅, together with the atoms to which they are bonded, form a 5- to 7-membered ring which may contain one or two hetero atoms selected from nitrogen, oxygen and sulfur;
R₁₅ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C2-C₁₀alkylsulfinylalkyl, C₂-C₁₀-alkylsulfonylalkyl, C₂-C₁₀alkylcarbonylalkyl, C₂-C₁₀alkoxycarbonylalkyl, C₁-C₁₀aminoalkyl, C₃-C₁₀dialkylaminoalkyl, C₂-C₁₀alkylaminoalkyl, C₁-C₁₀cyanoalkyl, C₄-C₁₀cycloalkylalkyl, C₁-C₁₀phenylalkyl, C₁-C₁₀heteroarylalkyl, C₁-C₁₀phenoxyalkyl, C₁-C₁₀heteroaryloxyalkyl, C₁-C₁₀nitroalkyl, C₃-C₁₀cycloalkyl, aryl or heteroaryl;
R₁₆ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₃-C₁₀cycloalkyl, aryl or heteroaryl;
R₁₇ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₂-C₁₀alkylcarbonylalkyl, C₃-C₁₀cycloalkyl, aryl or heteroaryl;
R₁₈ is hydrogen, C₂-C₁₀alkenyl, C₂-C₁₀alkynyl, C₁-C₁₀alkyl or C₁-C₁₀alkoxyalkyl; or
R₁₇ and R₁₈, together with the atoms to which they are bonded, form a 3- to 7-membered ring which may contain one or two hetero atoms selected from nitrogen, oxygen and sulfur;
Y is oxygen, sulfur, C—R₁₉ or N—R₃₆;
R₁₉ and R₃₆ are each independently of the other C₁-C₁₀alkyl, C₁-C₁₀haloalkyl, phenyl or heteroaryl; or
R₁₈ and R₁₉, or R₁₈ and R₃₆, together with the atom to which they are bonded, form a saturated, 5 to 7-membered ring which may contain one or two hetero atoms selected from nitrogen, oxygen and sulfur,
G₁, G₂, G₃, G₄, G₅, G₆, G₇, G₈, G₉ and G₁₀ are each independently of the others —C(X₁)—R₂₀, —C(X₂)—X₃—R₂₁, —C(X₄)—N(R₂₂)—R₂₃, —SO₂—R₂₄, —S(R₂₀₀)₃, —N(R₃₀₀)₄, —P(R₄₀₀)₄, —P(X₅)(R₂₅)—R₂₆ or —CH₂—X—R₂₇;
X₁, X₂, X₃, X₄, X₅ and X₆ are each independently of the others oxygen or sulfur,
R₂₀, R₂₁, R₂₄, R₂₇, and at least one of the substituents R₂₀₀, at least one of the substituents R₃₀₀, at least one of the substituents R₄₀₀, at least one of the substituents R₂₂ and R₂₃ and at least one of the substituents R₂₅ and R₂₆ are each C₉-C₃₂alkyl, C₉-C₃₂alkyl substituted by one or more C₁-C₈alkyl groups, C₉-C₃₂alkenyl, or C₉-C₃₂alkenyl substituted by one or more C₁-C₈alkyl groups,
the remaining substituent or substituents R₂₀₀ is or are additionally C₁-C₈alkyl, C₃-C₈cycloalkyl, phenyl, or phenyl substituted by alkyl, halogen, alkoxy, thioalkyl, haloalkyl, haloalkoxy, haloalkylthio, cyano or by nitro, or two substituents R₂₀₀, together with the sulfur atom to which they are bonded, form a 5 to 8-membered ring which may be interrupted by an oxygen, nitrogen or sulfur atom,
the remaining substituent or substituents R₃₀₀ is or are additionally hydrogen, C₁-C₈alkyl, C₃-C₈cycloalkyl, phenyl, or phenyl substituted by alkyl, halogen, alkoxy, thioalkyl, haloalkyl, haloalkoxy, haloalkylthio, cyano or nitro, or two substituents R₃₀₀, together with the nitrogen atom to which they are bonded, form a 5 to 8-membered ring which may be interrupted by an oxygen, nitrogen or sulfur atom,
the remaining substituent or substituents R₄₀₀ is or are additionally C₁-C₈alkyl, phenyl, or phenyl substituted by alkyl, halogen, alkoxy, thioalkyl, haloalkyl, haloalkoxy, haloalkylthio, cyano or by nitro, or two substituents R₄₀₀, together with the phosphorus atom to which they are bonded, form a 5- to 8-membered ring which may be interrupted by an oxygen, nitrogen or sulfur atom,
R₂₂ and R₂₃ are additionally, each independently of the other, hydrogen, C₁-C₁₀alkyl, C₂-C₁₀alkenyl, C₂-C₁₀alkynyl, C₁-C₁₀haloalkyl, C₁-C₁₀cyanoalkyl, C₁-C₁₀nitroalkyl, C₁-C₁₀-aminoalkyl, C₁-C₅alkylamino-C₁-C₅alkyl, C₂-C₈dialkylamino-C₁-C₅alkyl, C₃-C₇cycloalkyl-C₁-C₅alkyl, C₂-C₁₀alkoxyalkyl, C₄-C₁₀alkenyloxyalkyl, C₄-C₁₀alkynyloxyalkyl, C₂-C₁₀alkylthioalkyl, C₁-C₅alkylsulfoxyl-C₁-C₅alkyl, C₁-C₅alkylsulfonyl-C₁-C₅alkyl, C₂-C₈alkylideneamino-oxy-C₁-C₅alkyl, C₁-C₅alkylcarbonyl-C₁-C₅alkyl, C₁-C₅alkoxycarbonyl-C₁-C₅alkyl, C₁-C₅amino-carbonyl-C₁-C₅alkyl, C₂-C₈dialkylaminocarbonyl-C₁-C₅alkyl, C₁-C₅alkylcarbonylamino-C₁-C₅-alkyl, C₁-C₅alkylcarbonyl-(C₂-C₅alkyl)-aminoalkyl, C₃-C₆trialkylsilyl-C₁-C₅alkyl, phenyl-C₁-C₅alkyl, heteroaryl-C₁-C₅alkyl, phenoxy-C₁-C₅alkyl, heteroaryloxy-C₁-C₅alkyl, C₂-C₅alkenyl, C₂-C₅haloalkenyl, C₃-C₈cycloalkyl, phenyl, or phenyl substituted by C₁-C₃alkyl, C₁-C₃haloalkyl, C₁-C₃alkoxy, C₁-C₃haloalkoxy, halogen, cyano or by nitro, or heteroaryl or heteroarylamino, or heteroaryl or heteroarylamino substituted by C₁-C₃alkyl, C₁-C₃haloalkyl, C₁-C₃-alkoxy, C₁-C₃haloalkoxy, halogen, cyano or by nitro, diheteroarylamino, or diheteroarylamino substituted by C₁-C₃alkyl, C₁-C₃haloalkyl, C₁-C₃alkoxy, C₁-C₃haloalkoxy, halogen, cyano or by nitro, phenylamino, or phenylamino substituted by C₁-C₃alkyl, C₁-C₃haloalkyl, C₁-C₃alkoxy, C₁-C₃haloalkoxy, halogen, cyano or by nitro, diphenylamino, or diphenylamino substituted by C₁-C₃alkyl, C₁-C₃haloalkyl, C₁-C₃alkoxy, C₁-C₃haloalkoxy, halogen, cyano or by nitro, or C₃-C₇cycloalkylamino, di-C₃-C₇cycloalkylamino or C₃-C₇cycloalkoxy;
R₂₅ and R₂ are additionally hydrogen, C₁-C₁₀alkyl, C₂-C₁₀alkenyl, C₂-C₁₀alkynyl, C₁-C₁₀haloalkyl, C₁-C₁₀cyanoalkyl, C₁-C₁₀nitroalkyl, C₁-C₁₀aminoalkyl, C₁-C₅alkylamino-C₁-C₅alkyl, C₂-C₈-dialkylamino-C₁-C₅alkyl, C₃-C₇cycloalkyl-C₁-C₅alkyl, C₂-C₁₀alkoxyalkyl, C₄-C₁₀alkenyloxyalkyl, C₄-C₁₀alkynyloxyalkyl, C₂-C₁₀alkylthioalkyl, C₁-C₅alkylsulfoxyl-C₁-C₅alkyl, C₁-C₅alkylsulfonyl-C₁-C₅alkyl, C₂-C₈alkylideneamino-oxy-C₁-C₅alkyl, C₁-C₅alkylcarbonyl-C₁-C₅alkyl, C₁-C₅alkoxycarbonyl-C₁-C₅alkyl, C₁-C₅mino-carbonyl-C₁-C₅alkyl, C₂-C₈dialkylamino-carbonyl-C₁-C₅alkyl, C₁-C₅alkylcarbonylamino-C₁-C₅alkyl, C₁-C₅alkylcarbonyl-C₂-C₅alkyl)-aminoalkyl, C₃-C₆trialkylsilyl-C₁-C₅alkyl, phenyl-C₁-C₅alkyl, heteroaryl-C₁-C₅alkyl, phenoxy-C₁-C₅alkyl, heteroaryloxy-C₁-C₅alkyl, C₂-C₅alkenyl, C₂-C₅haloalkenyl, C₃-C₈cycloalkyl, phenyl, or phenyl substituted by C₁-C₃alkyl, C₁-C₃haloalkyl, C₁-C₃alkoxy, C₁-C₃haloalkoxy, halogen, cyano or by nitro, or heteroaryl or heteroarylamino, or heteroaryl or heteroarylamino substituted by C₁-C₃alkyl, C₁-C₃haloalkyl, C₁-C₃alkoxy, C₁-C₃haloalkoxy, halogen, cyano or by nitro, diheteroarylamino, or diheteroarylamino substituted by C₁-C₃alkyl, C₁-C₃haloalkyl, C₁-C₃alkoxy, C₁-C₃haloalkoxy, halogen, cyano or by nitro, phenylamino, or phenylamino substituted by C₁-C₃alkyl, C₁-C₃haloalkyl, C₁-C₃alkoxy, C₁-C₃haloalkoxy, halogen, cyano or by nitro, diphenylamino, or diphenylamino substituted by C₁-C₃alkyl, C₁-C₃haloalkyl, C₁-C₃alkoxy, C₁-C₃haloalkoxy, halogen, cyano or by nitro, or C₃-C₇cycloalkylamino, di-C₃-C₇cycloalkylamino, C₃-C₇cycloalkoxy, C₁-C₁₀alkoxy, C₁-C₁₀haloalkoxy, C₁-C₅alkylamino, C₂-C₈-dialkylamino, benzyloxy or phenoxy, it being possible for the benzyl and phenyl groups in turn to be substituted by C₁-C₃alkyl, C₁-C₃haloalkyl, C₁-C₃alkoxy, C₁-C₃haloalkoxy, halogen, cyano or by nitro;
Y₂ is oxygen, sulfur, C—R₁₄₀-R₁₄₁ or N—R₁₄₂;
R₅₅ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₂-C₁₀alkylcarbonylalkyl, C₃-C₁₀cycloalkyl, aryl or heteroaryl;
R₁₃₇ is hydrogen, C₁-C₁₀alkyl, C₂-C₁₀alkenyl, C₂-C₁₀alkynyl or C₁-C₁₀alkoxyalkyl; or
R₅₅ and R₁₃₇, together with the atoms to which they are bonded, form a 3- to 7-membered ring which may contain one or two hetero atoms selected from nitrogen, oxygen and sulfur;
R₁₃₈ and R₁₃₉ are each independently of the other hydrogen, C₁-C₁₀alkyl, C₂-C₁₀alkenyl, C₂-C₁₀alkynyl or C₂-C₁₀alkoxyalkyl, and
R₁₄₀ and R₁₄₁ are each independently of the other hydrogen, C₁-C₁₀alkyl, C₂-C₁₀alkenyl, C₂-C₁₀alkynyl or C₁-C₁₀alkoxyalkyl; or
R₅₅ and C—R₁₄₀, together with the atoms to which they are bonded, form a saturated or unsaturated, 3- to 7-membered ring which may contain one or two hetero atoms selected from nitrogen, oxygen and sulfur;
R₁₄₂ is hydrogen, C₁-C₁₀alkyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl. C₂-C₁₀alkylsulfinylalkyl, C₂-C₁₀alkylsulfonylalkyl, C₃-C₁₀cycloalkyl, aryl or heteroaryl; or
R₅₅ and N—R₁₄₂, together with the atoms to which they are bonded, form a saturated or unsaturated, 3- to 7-membered ring which may contain one or two hetero atoms selected from nitrogen, oxygen and sulfur; and to agronomically acceptable salts, isomers and enantiomers of such compounds.

The alkyl groups appearing in the definitions of substituents may be straight-chain or branched and are, for example, methyl, ethyl, n-propyl, isopropyl, n-butyl, sec-butyl, isobutyl, tert-butyl, and also the pentyl, hexyl, heptyl, octyl, nonyl and decyl isomers. Higher alkyl radicals, especially those having from 11 to 25 carbon atoms, preferably 11, 15, 17, 19 and 23 carbon atoms, are preferably unbranched. They may be substituted by one or more C₁-C₄alkyl groups, especially methyl, ethyl or isopropyl, preferably in the α-position to the carbonyl group to which they are adjacent. Haloalkyl is, for example, fluoromethyl, difluoromethyl, trifluoromethyl, chloromethyl, dichloromethyl, trichloromethyl, 2,2,2-trifluoroethyl, 2-fluoroethyl, 2-chloroethyl, pentafluoroethyl, 1,1-difluoro-2,2,2-trichloroethyl, 2,2,3,3-tetrafluoroethyl and 2,2,2-trichloroethyl; preferably trichloromethyl, difluorochloromethyl, difluoromethyl, trifluoromethyl and dichlorofluoromethyl. Alkoxyalkyl is, for example, methoxymethyl, ethoxymethyl, propoxyethyl, isopropoxyethyl, n-butoxymethyl, isobutoxy-n-butyl, sec-butoxymethyl and tert-butoxy-isopropyl, preferably methoxymethyl and ethoxymethyl. Alkoxy, alkenyl, alkynyl, alkoxyalkyl, alkylthio, alkylsulfonyl, alkylaminocarbonyl, dialkylaminocarbonyl, alkylaminoalkyl, phenylalkyl, nitroalkyl, aminoalkyl and N-alkoxycarbonyl-N-alkylaminoalkyl groups are derived from the mentioned alkyl radicals. The alkenyl and alkynyl groups may be mono- or poly-unsaturated. Alkenyl is to be understood as being, for example, vinyl, allyl, methallyl, 1-methylvinyl or but-2-en-1-yl. Higher alkenyl radicals, especially those having from 11 to 25 carbon atoms, preferably 17 or 19 carbon atoms, are preferably unbranched. They may be substituted by one or more C₁-C₄alkyl groups, especially methyl, ethyl or isopropyl, preferably in the α-position to the carbonyl group to which they are adjacent. Among those alkenyl groups special preference is given to those containing a single double bond in the cis configuration. Alkynyl is, for example, ethynyl, propargyl, but-2-yn-1-yl, 2-methylbutyn-2-yl or but-3-yn-2-yl. Haloalkyl groups have preferably a chain length of from 1 to 4 carbon atoms. Haloalkyl is, for example, fluoromethyl, difluoromethyl, trifluoromethyl, chloromethyl, dichloromethyl, trichloromethyl, 2,2,2-trifluoroethyl, 2-fluoroethyl, 2-chloroethyl, pentafluoroethyl, 1,1-difluoro-2,2,2-trichloroethyl, 2,2,3,3-tetrafluoroethyl and 2,2,2-trichloroethyl; preferably trichloromethyl, difluorochloromethyl, difluoromethyl, trifluoromethyl and dichlorofluoromethyl. As haloalkenyl, mono- or poly-halo-substituted alkenyl groups are suitable, the halogen being fluorine, chlorine, bromine or iodine, especially fluorine or chlorine, for example 2,2-difluoro-1-methylvinyl, 3-fluoropropenyl, 3-chloropropenyl, 3-bromopropenyl, 2,3,3-trifluoropropenyl, 2,3,3-trichloropropenyl and 4,4,4-trifluorobut-2-en-1-yl. Among the mono-, di- or tri-halo-substituted C₂-C₆alkenyl groups preference is given to those having a chain length of from 3 to 5 carbon atoms. Alkoxy groups have preferably a chain length of from 1 to 6 carbon atoms. Alkoxy is, for example, methoxy, ethoxy, propoxy, isopropoxy, n-butoxy, isobutoxy, sec-butoxy and tert-butoxy, and also the pentyloxy and hexyloxy isomers; preferably methoxy and ethoxy. Alkylcarbonyl is preferably acetyl or propionyl. Alkoxycarbonyl is, for example, methoxycarbonyl, ethoxycarbonyl, propoxycarbonyl, isopropoxycarbonyl, n-butoxycarbonyl, isobutoxycarbonyl, sec-butoxycarbonyl or tert-butoxycarbonyl; preferably methoxycarbonyl or ethoxycarbonyl. Alkylthio groups have preferably a chain length of from 1 to 4 carbon atoms. Alkylthio is, for example, methylthio, ethylthio, propylthio, isopropylthio, n-butylthio, isobutylthio, sec-butylthio or tert-butylthio, preferably methylthio and ethylthio. Alkylsulfinyl is, for example, methylsulfinyl, ethylsulfinyl, propylsulfinyl, isopropylsulfinyl, n-butylsulfinyl, isobutylsulfinyl, sec-butylsulfinyl or tert-butylsulfinyl; preferably methylsulfinyl or ethylsulfinyl. Alkylsulfonyl is, for example, methylsulfonyl, ethylsulfonyl, propylsulfonyl, isopropylsulfonyl, n-butylsulfonyl, isobutylsulfonyl, sec-butylsulfonyl or tert-butylsulfonyl; preferably methylsulfonyl or ethylsulfonyl. Alkylamino is, for example, methylamino, ethylamino, n-propylamino, isopropylamino or the butylamino isomers. Dialkylamino is, for example, dimethylamino, methylethylamino, diethylamino, n-propylmethylamino, dibutylamino and diisopropylamino. Alkoxyalkyl groups preferably have from 1 to 6 carbon atoms. Alkoxyalkyl is, for example, methoxymethyl, methoxyethyl, ethoxymethyl, ethoxyethyl, n-propoxymethyl, n-propoxyethyl, isopropoxymethyl or isopropoxyethyl. Alkylthioalkyl is, for example, methylthiomethyl, methylthioethyl, ethylthiomethyl, ethylthioethyl, n-propylthiomethyl, n-propylthioethyl, isopropylthiomethyl, isopropylthioethyl, butylthiomethyl, butylthioethyl or butylthiobutyl. Phenyl may be in substituted form, in which case the substituents may be in the ortho-, meta- and/or para-position(s). Preferred substituent positions are the positions ortho and para to the ring attachment position.

Aryl is, for example, phenyl or naphthyl. These groups may also be substituted, Phenyl, including phenyl as part of a substituent such as phenylalkyl, may be substituted, for example, when not otherwise indicated in the definitions, by halogen, nitro, cyano, C₁-C₄alkyl, C₁-C₄alkoxy, C₁-C₄alkylthio, C₁-C₄alkylsulfoxy, C₁-C₄alkylsulfonyl, carboxyl, C₁-C₄-alkoxycarbonyl, amino, C₁-C₄alkylamino, C₁-C₄dialkylamino or by C₁-C₄alkylcarbonylamino.

Heteroaryl groups are usually aromatic heterocycles that contain preferably from 1 to 3 hetero atoms such as nitrogen, sulfur and oxygen. Examples of suitable heterocycles and heteroaromatic compounds are: pyrrolidine, piperidine, pyran, dioxane, azetidine, oxetane, pyridine, pyrimidine, triazine, thiazole, thiadiazole, imidazole, oxazole, isoxazole and pyrazine, furan, morpholine, piperazine, pyrazole, benzoxazole, benzothiazole, quinoxaline and quinoline. Those heterocycles and heteroaromatic compounds may be further substituted, for example by halogen, alkyl, alkoxy, haloalkyl, haloalkoxy, nitro, cyano, thioalkyl, alkylamino or by phenyl.

In the context of the present invention, 3- to 7-membered rings are understood to be ring systems which, besides the carbon atoms and in addition to any hetero atoms that may already be present in the ring of the substituents Q, may contain one or more hetero atoms such as nitrogen, oxygen and/or sulfur. They may be saturated or unsaturated. For example, in the case of the group Q₂, the unsaturated bond may be formed by the substituents R₆ and R₇. Such ring systems preferably contain from 5 to 7 ring atoms.

3- to 7-membered rings, including the cycloalkyls such as, for example, cyclopropyl, cyclobutyl, cyclopentyl, cyclohexyl, cycloheptyl and cyclooctyl may also be substituted. Suitable substituents are halogen, hydroxy, nitro, cyano, C₁-C₄alkylcarbonyl, C₁-C₄alkoxycarbonyl, C₁-C₄alkyl, C₁-C₄haloalkyl, keto, C₂-C₄alkenyloxyimino, C₁-C₄alkoxy, C₁-C₄alkoxyalkoxy, C₁-C₄alkylthio, or one of the following 3 groups 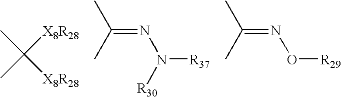
wherein X₆ is sulfur or oxygen, R₂₈ is C₁-C₄alkoxy or both R₂₈, together with the —X₈—C—X₈— bridge to which they are bonded, form a 5 or 6-membered ring which may be substituted by methyl, ethyl, methoxy or by a keto group,
R₂₉ is C₁-C₄alkyl, C₁₋₄haloalkyl, C₂-C₄alkenyl or C₂-C₄haloalkenyl,
R₃₀ and R₃₇ are each independently of the other C₁-C₄alkyl, phenyl or C₂-C₄alkenyl, or R₃₀ and R₃₇, together with the nitrogen atom to which they are bonded, form a 5- or 6-membered ring which may contain a hetero atom selected from nitrogen, oxygen and sulfur.

In the substituent definitions, the number of carbon atoms indicates the total number of carbon atoms in the alkyl, alkenyl and alkynyl groups and groups derived therefrom such as, for example, haloalkyl or alkenyloxy. C₂-C₃Alkoxyalkyl accordingly includes methoxymethyl, methoxyethyl and ethoxymethyl. C₃Alkoxycarbonylalkyl includes methoxycarbonylethyl and ethoxycarbonylmethyl.

The compounds of formula I may, also in dependence upon the nature of the substituents, occur as geometric and/or optical isomers and isomeric mixtures and as tautomers and tautomeric mixtures. The present invention relates likewise to such compounds of formula I.

When, for example, the ring formed by R₄ and R₅ together is asymmetrically substituted, fused or spiro-linked, the compound of formula I may occur, for example, as an isomer of formula Id

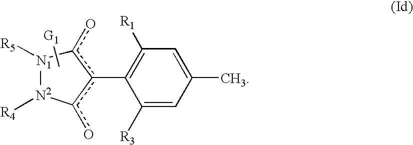

The invention relates also to the salts which the compounds of formula I are able to form preferably with amines, alkali metal and alkaline earth metal bases or quaternary ammonium bases. Suitable salt formers are described, for example, in WO 98/41089.

The invention relates also to the salts which the compounds of formula I are able to form with amines, alkali metal and alkaline earth metal bases or quaternary ammonium bases. Among the alkali metal and alkaline earth metal hydroxides as salt formers, special mention should be made of the hydroxides of lithium, sodium, potassium, magnesium and calcium, especially the hydroxides of sodium and potassium.

Examples of amines suitable for ammonium salt formation include ammonia as well as primary, secondary and tertiary C₁-C₁₈alkylamines, C₁-C₄hydroxyalkylamines and C₂-C₄alkoxyalkylamines, for example methylamine, ethylamine, n-propylamine, isopropylamine, the four butylamine isomers, n-amylamine, isoamylamine, hexylamine, heptylamine, octylamine, nonylamine, decylamine, pentadecylamine, hexadecylamine, heptadecylamine, octadecylamine, methyl-ethylamine, methyl-isopropylamine, methyl-hexylamine, methyl-nonylamine, methyl-pentadecylamine, methyl-octadecylamine, ethyl-butylamine, ethyl-heptylamine, ethyl-octylamine, hexyl-heptylamine, hexyl-octylamine, dimethylamine, diethylamine, di-n-propylamine, diisopropylamine, di-n-butylamine, di-n-amylamine, diisoamylamine, dihexylamine, diheptylamine, dioctylamine, ethanolamine, n-propanolamine, isopropanolamine, N,N-diethanolamine, N-ethylpropanolamine, N-butylethanolamine, allylamine, n-butenyl-2-amine, n-pentenyl-2-amine, 2,3-dimethylbutenyl-2-amine, dibutenyl-2-amine, n-hexenyl-2-amine, propylenediamine, trimethylamine, triethylamine, tri-n-propylamine, triisopropylamine, tri-n-butylamine, triisobutylamine, tri-sec-butylamine, tri-n-amylamine, methoxyethylamine and ethoxyethylamine; heterocyclic amines, for example pyridine, quinoline, isoquinoline, morpholine, piperidine, pyrrolidine, indoline, quinuclidine and azepine; primary arylamines, for example anilines, methoxyanilines, ethoxyanilines, o-, m- and p-toluidines, phenylenediamines, benzidines, naphthylamines and o-, m- and p chloroanilines; but especially triethylamine, isopropylamine and diisopropylamine.

Preferred quaternary ammonium bases suitable for salt formation correspond, for example, to the formula [N(RₐR_{b}R_{c}R_{d})]OH wherein Rₐ, R_{b}, R_{c} and R_{d} are each independently of the others C₁-C₄alkyl. Other suitable tetraalkylammonium bases with other anions can be obtained, for example, by anion exchange reactions.

Among the compounds of formula I preference is given to those wherein Q is Q₁.

Further preferred compounds of formula I are those wherein R₄ and R₅ are each independently of the other C₁-C₆alkyl, C₁-C₆haloalkyl, C₂-C₆alkoxyalkyl, C₄-C₆alkenyloxyalkyl, C₄-C₆alkynyloxyalkyl, C₂-C₆alkylthioalkyl, C₂-C₆alkylsulfoxylalkyl, C₂-C₆alkylsulfonylalkyl, C₂-C₆alkylcarbonylalkyl, C₃-C₆-N-alkoxy-iminoalkyl, C₃-C₆alkoxycarbonylalkyl, C₁-C₆aminoalkyl, C₂-C₆dialkylaminoalkyl, C₃-C₈alkylaminoalkyl, C₁-C₆cyanoalkyl, C₄-C₈cycloalkylalkyl, C₇-C₈phenylalkyl, C₇-C₈heteroarylalkyl, C₇-C₈phenoxyalkyl, C₇-C₈heteroaryloxyalkyl, C₄-C₆alkylideneaminooxyalkyl, C₁-C₆nitroalkyl, C₄-C₈trialkylsilylalkyl, C₄-C₆alkylaminocarbonyl, C₃-C₆dialkylaminocarbonyl, C₄-C₈alkylaminocarbonyloxyalkyl, C₄-C₈dialkylaminocarbonyloxyalkyl, C₄-C₈alkoxycarbonylaminoalkyl, C₄-C₈-N-alkoxycarbonyl-N-alkylaminoalkyl, C₃-C₈cycloalkyl, aryl or heteroaryl, or
R₄ and R₅, together with the atoms to which they are bonded, form a 5 to 7-membered ring.

Especially preferred compounds of formula I are those wherein R₁ and R₃ are each independently of the other ethyl, haloethyl, ethynyl, C₁-C₂alkoxy, C₁-C₂haloalkoxy or C₁-C₂-alkylcarbonyl; Q is a group Q₁ wherein G₁ is —C(O)—R₂₀ wherein R₂₀ is C₉-C₂₅alkyl, C₉-C₂₅alkyl substituted by one or more C₁-C₄alkyl groups, C₉-C₂₅alkenyl, or C₉-C₂₅alkenyl substituted by one or more C₁-C₄alkyl groups, and R₄ and R₅, together with the nitrogen atoms to which they are bonded, form a 5 to 7-membered ring which may contain one or two hetero atoms selected from nitrogen, sulfur and, especially, oxygen.

The compounds of formula I can be prepared, according to methods known per se, by reacting a compound of formula II 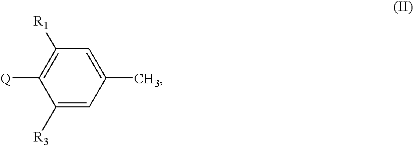
wherein R₁ and R₃ are as defined for formula I and Q is Q₁, Q₂, Q₃, Q₄, Q₅, Q₆, Q₇, Q₈, Q₉ or Q₁₀, wherein the substituents G₁, G₂, G₃, G₄, G₅, G₆, G₇, G₈, G₉ and G₁₀ are hydrogen, with a compound of formula III
Hal-G (III),
wherein Hal is chlorine, bromine or iodine, and G is —C(X₁)—R₂₀, —C(X₂)—X₃—R₂₁, —C(X₄)—N(R₂₂)—R₂₃, —SO₂—R₂₄, —S(R₂₀₀)₃, —N(R₃₀₀)₄, —P(R₄₀₀)₄, —P(X₅)(R₂₅)—R₂₈ or —CH₂—X₆—R₂₇, wherein X₁, X₂, X₃, X₄, X₅ and X₆ and R₂₀, R₂₁, R₂₂, R₂₃, R₂₄, R₂₀₀, R₃₀₀, R₄₀₀, R₂₅, R₂₆ and R₂₇ are as defined, in the presence of an inert solvent and a base.

The compounds of formula II are known and are described, for example, in WO 01/17972. The compounds of formula III are also known; they can be alkylated by conventional methods, for example metallation reactions.

Suitable bases are, for example, amines such as trimethylamine and triethylamine, and also tri-alkali metal phosphates, alkali metal and alkaline earth metal hydrides, alkali metal and alkaline earth metal amides or alkali metal alcoholates, for example tripotassium phosphate, sodium hydride, lithium diisopropylamide (LDA), sodium tert-butanolate or potassium tert-butanolate. Special preference is given to trimethylamine.

Where appropriate, catalysts which increase the activity of the acid halides, e.g. 4N,N-dimethylaminopyridine, may be also used in the preparation of the compounds of formula I.

Suitable solvents are, for example, aromatic hydrocarbons such as, for example, xylene or toluene, ethers such as tetrahydrofuran, dioxane or ethylene glycol dimethyl ether, dimethyl sulfoxide, or tertiary amides such as dimethylformamide, N-methylpyrrolidinone or dimethylacetamide, or acyclic ureas such as N,N′-dimethylpropylene urea.

For use, according to the invention, of the compounds of formula I, or of compositions comprising them, there come into consideration all methods of application customary in agriculture, for example pre-emergence application, post-emergence application and seed dressing, and also various methods and techniques such as, for example, the controlled release of active ingredient. For that purpose a solution of the active ingredient is applied to mineral granule carriers or polymerised granules (urea/formaldehyde) and dried. If required, it is also possible to apply a coating (coated granules), which allows the active ingredient to be released in metered amounts over a specific period of time.

The compounds of formula I may be used as herbicides in their unmodified form, that is to say as obtained in the synthesis, but they are preferably formulated in customary manner together with the adjuvants conventionally employed in formulation technology, for example into emulsifiable concentrates, directly sprayable or dilutable solutions, dilute emulsions, wettable powders, soluble powders, dusts, granules or microcapsules. Such formulations are described, for example, on pages 9 to 13 of WO 97/34485. As with the nature of the compositions, the methods of application, such as spraying, atomising, dusting, wetting, scattering or pouring, are chosen in accordance with the intended objectives and the prevailing circumstances.

The formulations, that is to say the compositions, preparations or mixtures comprising the compound (active ingredient) of formula I or at least one compound of formula I and, usually, one or more solid or liquid formulation adjuvants, are prepared in known manner, e.g. by homogeneously mixing and/or grinding the active ingredients with the formulation adjuvants, for example solvents or solid carriers. Surface-active compounds (surfactants) may also be used in addition in the preparation of the formulations. Examples of solvents and solid carriers are given, for example, on page 6 of WO 97/34485.

Depending upon the nature of the compound of formula I to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, on pages 7 and 8 of WO 97/34485. In addition, the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna 1981, and M. and J. Ash, “Encyclopedia of Surfactants”, Vol. I-III, Chemical Publishing Co., New York, 1980-81, are also suitable for the preparation of the herbicidal compositions according to the invention.

The activity of herbicidal and plant-growth-inhibiting compositions according to the invention containing a herbicidally effective amount of compound of formula I can be increased by adding spray tank adjuvants.

Such adjuvants may be, for example: non-ionic surfactants, mixtures of non-ionic surfactants, mixtures of anionic surfactants with non-ionic surfactants, cationic surfactants, organosilicon surfactants, mineral oil derivatives with and without surfactants, vegetable oil derivatives with and without added surfactant, alkylated derivatives of oils of vegetable or mineral origin with and without surfactants, fish oils and other animal oils that are animal in nature and also alkyl derivatives thereof with and without surfactants, naturally occurring higher fatty acids, preferably containing from 8 to 28 carbon atoms, and alkyl ester derivatives thereof, organic acids containing an aromatic ring system and one or more carboxylic acid ester(s), and also alkyl derivatives thereof, and suspensions of polymers of vinyl acetate or copolymers of vinyl acetate/acrylic acid esters. Mixtures of individual adjuvants with one another and also in combination with organic solvents can result in a further increase in action.

Suitable non-ionic surfactants are, for example, polyglycol ether derivatives of aliphatic or cycloaliphatic alcohols, of saturated or unsaturated fatty acids and of alkylphenols, which may preferably contain from 3 to 30 glycol ether groups and from 8 to 20 carbon atoms in the (aliphatic) hydrocarbon radical and from 6 to 18 carbon atoms in the alkyl radical of the alkylphenols.

Further suitable non-ionic surfactants are water-soluble adducts of polyethylene oxide with polypropylene glycol, ethylenediaminopolypropylene glycol and alkylpolypropylene glycol, containing preferably from 1 to 10 carbon atoms in the alkyl chain, which adducts contain from 20 to 250 ethylene glycol ether groups and from 10 to 100 propylene glycol ether groups. These compounds usually contain from 1 to 5 ethylene glycol units per propylene glycol unit.

Further examples of non-ionic surfactants that may be mentioned include nonylphenol polyethoxyethanols, castor oil polyglycol ethers, polypropylene/polyethylene oxide adducts, tributylphenoxypolyethoxyethanol, polyethylene glycol and octylphenoxypolyethoxy ethanol.

Furthermore, fatty acid esters of polyoxyethylene sorbitan, such as polyoxyethylene sorbitan trioleate, also come into consideration.

Among anionic surfactants, preference is given to, especially, alkyl sulfates, alkyl sulfonates, alkylaryl sulfonates and alkylated phosphoric acids, and also ethoxylated derivatives thereof. The alkyl radicals usually contain from 8 to 24 carbon atoms.

Preferred non-ionic surfactants are known under the following trade names:
polyoxyethylene cocoalkylamine (e.g. AMIET® 105 (Kao Co.)), polyoxyethylene oleylamine (e.g. AMIET® 415 (Kao Co.)), nonylphenol polyethoxyethanols, polyoxyethylene stearylamine (e.g. AMIET® 320 (Kao Co.)), N-polyethoxyethylamines (e.g. GENAMIN® (Hoechst AG)), N,N,N′,N′-tetra(polyethoxypolypropoxyethyl)ethylene-diamines (e.g. TERRONIL® and TETRONIC® (BASF Wyandotte Corp.)), BRIJ® (Atlas Chemicals), ETHYLAN® CD and ETHYLAN® D (Diamond Shamrock), GENAPOL® C, GENAPOL® O, GENAPOL® S and GENAPOL® X080 (Hoechst AG), EMULGEN® 104P, EMULGEN® 109P and EMULGEN® 408 (Kao Co.); DISTY® 125 (Geronazzo), SOPROPHOR® CY 18 (Rhone Poulenc S.A.); NONISOL® (Ciba-Geigy), MYRJ® (ICI); TWEEN® (ICI); EMULSOGEN® (Hoechst AG); AMIDOX® (Stephan Chemical Co.), ETHOMID® (Armak Co.); PLURONIC® (BASF Wyandotte Corp.), SOPROPHOR® 461P (Rhone Poulenc S.A.), SOPROPHOR® 496/P (Rhone Poulenc S.A.), ANTAROX FM-63 (Rhone Poulenc S.A.), SLYGARD 309 (Dow Corning), SILWET 408, SILWET L-7607N (Osi-Specialities).

The cationic surfactants are especially quaternary ammonium salts that contain at least one alkyl radical having from 8 to 22 carbon atoms as N-substituent and that have lower, unsubstituted or halogenated alkyl, benzyl or hydroxy-lower alkyl radicals as further substituents. The salts are preferably in the form of halides, methyl sulfates or ethyl sulfates, for example stearyltrimethylammonium chloride or benzyldi(2-chloroethyl)ethylammonium bromide.

The oils used may be of either mineral or natural origin. The natural oils may, furthermore, be of animal or vegetable origin. In the case of animal oils, preference is given especially to derivatives of beef tallow, but also to fish oils (e.g. sardine oil) and derivatives thereof. Vegetable oils are usually seed oils of various origins. As examples of vegetable oils especially used, mention may be made of coconut, rapeseed and sunflower oils and derivatives thereof.

In the composition according to the invention, the amounts of oil additive employed are generally from 0.01 to 2%, based on the spray mixture. The oil additive can, for example, be added to the spray tank in the desired concentration after the spray mixture has been prepared.

In the composition according to the invention preferred oil additives comprise an oil of vegetable origin such as, for example, rapeseed oil or sunflower oil, alkyl esters of oils of vegetable origin such as, for example, the methyl derivatives, or mineral oils.

Especially preferred oil additives comprise alkyl esters of higher fatty acids (C₈-C₂₂), especially the methyl derivatives of C₁₂-C₁₈ fatty acids, for example the methyl esters of lauric acid, palmitic acid and oleic acid. Those esters are known as methyl laurate (CAS-111-82-0), methyl palmitate (CAS-112-39-0) and methyl oleate (CAS-112-62-9).

The application and action of the oil additives can be improved by combining them with surface-active substances such as non-ionic, anionic or cationic surfactants. Examples of suitable anionic, non-ionic and cationic surfactants are listed in WO 97/34485 on pages 7 and 8.

Preferred surface-active substances are anionic surfactants of the dodecylbenzylsulfonate type, especially the calcium salts thereof, and also non-ionic surfactants of the fatty alcohol ethoxylate type. Special preference is given to ethoxylated C₁₂-C₂₂ fatty alcohols having a degree of ethoxylation of from 5 to 40. Examples of commercially available preferred surfactants are the Genapol types (Clariant AG, Muttenz, Switzerland). The concentration of the surface-active substances based on the total additive is generally from 1 to 30% by weight.

Examples of oil additives consisting of mixtures of oils or mineral oils or derivatives thereof with surfactants are Edenor ME SU®, Emery 2231® (Henkel subsidiary Cognis GMBH, DE), Turbocharge® (Zeneca Agro, Stoney Creek, Ontario, CA) or, more especially, Actipronn (BP Oil UK Limited, GB).

The addition of an organic solvent to the oil additive/surfactant mixture can, furthermore, bring about a further increase in action. Suitable solvents are, for example, Solvesso® (ESSO) or Aromatic Solvent® (Exxon Corporation) types.

The concentration of those solvents can be from 10 to 80% of the total weight.

Such oil additives, which are also described, for example, in U.S. Pat. No. 4,834,908, are especially preferred for the composition according to the invention. An especially preferred oil additive is known under the name MERGE®; it can be obtained from the BASF Corporation and a basic description thereof is given, for example, in U.S. Pat. No. 4,834,908 in col. 5, as Example COC-1. A further oil additive that is preferred according to the invention is SCORE® (Novartis Crop Protection Canada).

Surfactants, oils, especially vegetable oils, derivatives thereof such as alkylated fatty acids and mixtures thereof, for example with preferably anionic surfactants such as alkylated phosphoric acids, alkyl sulfates and alkylaryl sulfonates and also higher fatty acids, which are customary in formulation and adjuvant technology and may also be used in the compositions according to the invention and spray tank solutions thereof, are described, inter alia, in “McCutcheon's Detergents and Emulsifiers Annual” MC Publishing Corp., Ridgewood N.J., 1998, Stache, H., “Tensid-Taschenbuch”, Carl Hanser Verlag, Munich/Vienna, 1990, M. and J. Ash, “Encyclopedia of Surfactants”, Vol l-IV, Chemical Publishing Co., New York, 1981-89, G. Kapusta, “A Compendium of Herbicide Adjuvants”, Southern Illinois Univ., 1998, L. Thomson Harvey, “A Guide to Agricultural Spray Adjuvants Used in the United States”, Thomson Pubns., 1992.

The herbicidal formulations usually contain from 0.1 to 99% by weight, especially from 0.1 to 95% by weight, of herbicide, from 1 to 99.9% by weight, especially from 5 to 99.8% by weight, of a solid or liquid formulation adjuvant, and from 0 to 25% by weight, especially from 0.1 to 25% by weight, of a surfactant. Whereas commercial products are usually formulated as concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients.

The compounds of formula I are generally applied to the plant or the locus thereof at rates of application of from 0.001 to 4 kg/ha, especially from 0.005 to 2 kg/ha. The concentration required to achieve the desired effect can be determined by experiment. It is dependent on the nature of the action, the stage of development of the cultivated plant and of the weed and on the application (place, time, method) and may vary within wide limits as a function of those parameters.

The compounds of formula I are distinguished by herbicidal and growth-inhibiting properties, allowing them to be used in crops of useful plants, especially cereals, cotton, soybeans, sugar beet, sugar cane, plantation crops, rape, maize and rice, and also for non-selective weed control. The term “crops” is to be understood as including also crops that have been made tolerant to herbicides or classes of herbicides as a result of conventional methods of breeding or genetic engineering techniques, these being, for example, IMI Maize, Poast Protected Maize (sethoxydim tolerance), Liberty Link Maize, B.t./Liberty Link Maize, IMI/Liberty Link Maize, IMI/Liberty Link/B.t. Maize, Roundup Ready Maize and Roundup Ready/B.t. Maize.

The weeds to be controlled may be either monocotyledonous or dicotyledonous weeds, such as, for example, Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica.

It has been shown, surprisingly, that particular safeners known from U.S. Pat. No. 5,041,157, U.S. Pat. No. 5,541,148, U.S. Pat. No. 5,006,656, EP-A-0 094 349, EP-A-0 551 650, EP-A-0 268 554, EP-A-0 375 061, EP-A-0 174 562, EP-A-492 366, WO 91/7874, WO 94/987, DE-A-196 12 943, WO 96/29870, WO 98/13361, WO 98/39297, WO 98/27049, EP-A-0 716 073, EP-A-0 613 618, U.S. Pat. No. 5,597,776, EP-A0 430 004, DE-A-4 331 448, WO 99/16744, WO 00/30447 and WO 00/00020 are suitable for mixing with the herbicidal composition according to the invention. The present invention accordingly relates also to a selectively herbicidal composition for controlling grasses and weeds in crops of useful plants, especially in crops of maize and cereals, that comprises a herbicide of formula I and a safener (counter-agent, antidote) and that protects the useful plants, but not the weeds, against the phytotoxic action of the herbicide, as well as to the use of such a composition in the control of weeds in crops of useful plants.

The safeners correspond preferably to a compound of formula X 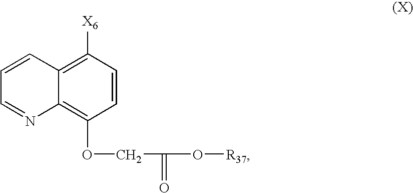
wherein
R₃₇ is hydrogen, C₁-C₈alkyl, or C₁-C₈alkyl substituted by C₁-C₆alkoxy or by C₃-C₆alkenyloxy; and X₇ is hydrogen or chlorine; or to a hydrate or salt of compounds of formula X such as described, for example, in Swiss Patent Applications 2135/00 and 2066/01; or to a compound of formula XI 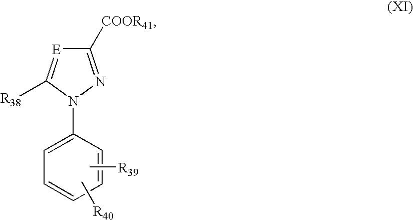
   wherein E is nitrogen or methine;
R₃₈ is —CCl₃, phenyl, or phenyl substituted by halogen;
R₃₉ and R₄₀ are each independently of the other hydrogen or halogen; and
R₄₁ is C₁-C₄alkyl; or to a compound of formula XII 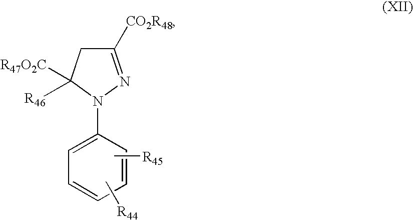
   wherein R₄₄ and R₄₅ are each independently of the other hydrogen or halogen, and
R₄₆, R₄₇ and R₄₈ are each independently of the others C₁-C₄alkyl; or to a compound of formula XIII 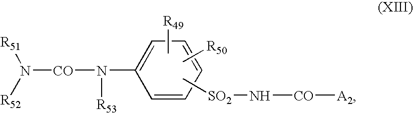
   wherein A₂ is a group 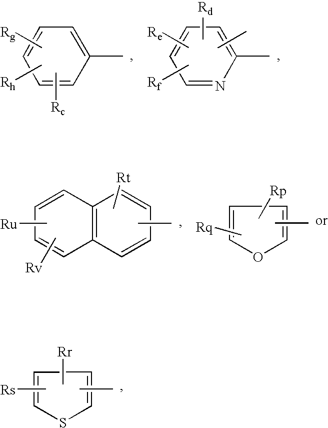
R₅, and R₅₂ are each independently of the other hydrogen, C₁-C₈alkyl, C₃-C₈cycloalkyl, C₃-C₆alkenyl, C₃-C₆alkynyl, 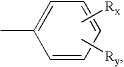
or C₁-C₄alkyl substituted by C₁-C₄alkoxy or by 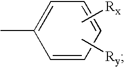
or R₅₁ and R₅₂ together form a C₄-C₆alkylene bridge which may be interrupted by oxygen, sulfur, SO, SO₂, NH or by —N(C₁-C₄alkyl)-;
R₅₃ is hydrogen or C₁-C₄alkyl;
R₄₉ is hydrogen, halogen, cyano, trifluoromethyl, nitro, C₁-C₄alkyl, C₁-C₄alkoxy, C₁-C₄alkylthio, C₁-C₄alkylsulfinyl, C₁-C₄alkylsulfonyl, —COORⱼ, —CONRₖRₘ, —CORₙ, —SO₂NRₖRₘ or —OSO₂—C₁-C₄alkyl;
R₉ is hydrogen, halogen, cyano, nitro, C₁-C₄alkyl, C₁-C₄haloalkyl, C₁-C₄alkylthio, C₁-C₄alkylsulfinyl, C₁-C₄alkylsulfonyl, —COORⱼ, —CONRₖRₘ, —CORₙ, —SO₂NRₖRₘ, —OSO₂—C₁-C₄alkyl, C₁-C₆alkoxy, or C₁-C₆alkoxy substituted by C₁-C₄alkoxy or by halogen, C₃-C₆alkenyloxy, or C₃-C₆alkenyloxy substituted by halogen, or C₃-C₆alkynyloxy, or R₄₉ and R₅₀ together form a C₃-C₄alkylene bridge which may be substituted by halogen or by C₁-C₄alkyl or together form a C₃-C₄alkenylene bridge which may be substituted by halogen or by C₁-C₄alkyl or together form a C₄alkadienylene bridge which may be substituted by halogen or by C₁-C₄alkyl;
R₅₀ and Rₕ are each independently of the other hydrogen, halogen, C₁-C₄alkyl, trifluoromethyl, C₁-C₆alkoxy, C₁-C₆alkylthio or —COORⱼ;
R_{c} is hydrogen, halogen, nitro, C₁-C₄alkyl or methoxy; Rd is hydrogen, halogen, nitro, C₁-C₄alkyl, C₁-C₄alkoxy, C₁-C₄alkylthio, C₁-C₄alkylsulfinyl, C₁-C₄alkylsulfonyl, —COORⱼ or —CONRₖRₘ;
Rₑ is hydrogen, halogen, C₁-C₄alkyl, —COORⱼ, trifluoromethyl or methoxy, or R_{d} and Rₑ together form a C₃-C₄alkylene bridge;
Rp is hydrogen, halogen, C₁-C₄alkyl, —COORⱼ, trifluoromethyl or methoxy; Rq is hydrogen, halogen, nitro, C₁-C₄alkyl, C₁-C₄alkoxy, C₁-C₄alkylthio, C₁-C₄alkylsulfinyl, C₁-C₄alkylsulfonyl, —COORⱼ or —CONRₖRₘ; or Rp and Rq together form a C₃-C₄alkylene bridge;
Rr is hydrogen, halogen, C₁-C₄alkyl, —COORⱼ, trifluoromethyl or methoxy; Rs is hydrogen, halogen, nitro, C₁-C₄alkyl, C₁-C₄alkoxy, C₁-C₄alkylthio, C₁-C₄alkylsulfinyl, C₁-C₄alkylsulfonyl, —COORⱼ or —CONRₖRₘ; or Rr and Rs together form a C₃-C₄alkylene bridge;
Rt is hydrogen, halogen, C₁-C₄alkyl, —COORⱼ, trifluoromethyl or methoxy; Ru is hydrogen, halogen, nitro, C₁-C₄alkyl, C₁-C₄alkoxy, C₁-C₄alkylthio, C₁-C₄alkylsulfinyl, C₁-C₄alkylsulfonyl, —COORⱼ or —CONRₖRₘ; or Rv and Ru together form a C₃-C₄alkylene bridge;
R_{f} and Rv are each hydrogen, halogen or C₁-C₄alkyl;
Rₓ and R_{y} are each independently of the other hydrogen, halogen, C₁-C₄alkyl, C₁-C₄alkoxy, C₁-C₄alkylthio, —COOR₅₄, trifluoromethyl, nitro or cyano;
Rⱼ, Rₖ and Rₘ are each independently of the others hydrogen or C₁-C₄alkyl; or
Rₖ and Rₘ together form a C₄-C₆alkylene bridge which may be interrupted by oxygen, NH or by —N(C₁-C₄alkyl)-;
Rₙ is C₁-C₄alkyl, phenyl, or phenyl substituted by halogen, C₁-C₄alkyl, methoxy, nitro or by trifluoromethyl;
R₅₄ is hydrogen, C₀-C₁₀alkyl, C₁-C₄alkoxy-C₁-C₄alkyl, C₁-C₄alkylthio-C₁-C₄alkyl, di-C₁-C₄-alkylamino-C₁-C₄alkyl, halo-C₁-C₈alkyl, C₂-C₈alkenyl, halo-C₂-C₈alkenyl, C₃-C₈alkynyl, C₃-C₇cycloalkyl, halo-C₃-C₇cycloalkyl, C₁-C₈alkylcarbonyl, allylcarbonyl, C₃-C₇cycloalkylcarbonyl, benzoyl which is unsubstituted or substituted on the phenyl ring by up to three identical or different halogen, C₁-C₄alkyl, halo-C₁-C₄alkyl, halo-C₁-C₄alkoxy or C₁-C₄alkoxy substituents; or furoyl, thienyl; or C₁-C₄alkyl substituted by phenyl, halophenyl, C₁-C₄alkylphenyl, C₁-C₄alkoxyphenyl, halo-C₁-C₄alkylphenyl, halo-C₁-C₄alkoxyphenyl, C₁-C₆alkoxycarbonyl, C₁-C₄alkoxy-C₁-C₈alkoxycarbonyl, C₃-C₈alkenyloxycarbonyl, C₃-C₈alkynyloxycarbonyl, C₁-C₈alkylthiocarbonyl, C₃-C₈alkenylthiocarbonyl, C₃-C₈alkynylthiocarbonyl, carbamoyl, mono-C₁-C₄alkylaminocarbonyl, di-C₁-C₄alkylaminocarbonyl; or phenylaminocarbonyl which is unsubstituted or substituted on the phenyl by up to three identical or different halogen, C₁-C₄alkyl, halo-C₁-C₄alkyl, halo-C₁-C₄alkoxy or C₁-C₄alkoxy substituents or by one cyano or nitro substituent, or dioxolan-2-yl which is unsubstituted or substituted by one or two C₁-C₄alkyl radicals, or dioxan-2-yl which is unsubstituted or substituted by one or two C₁-C₄alkyl radicals, or C₁-C₄alkyl which is substituted by cyano, nitro, carboxyl or by C₁-C₈alkylthio-C₁-C₈alkoxycarbonyl;
   or to a compound of formula XIV 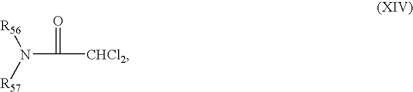
   wherein R₅₆ and R₅₇ are each independently of the other C₁-C₆alkyl or C₂-C₆alkenyl; or R₅₆ and R₅₇ together are 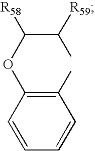
   R₅₈ and R₅₉ are each independently of the other hydrogen or C₁-C₆alkyl; or R₅₆ and R₅₇ together are 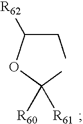
R₆₀ and R₆, are each independently of the other C₁-C₄alkyl, or R₆₀ and R₆₁ together are —(CH₂)₅—;
R₆₂ is hydrogen, C₁-C₄alkyl or 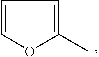
or R₅₆ and R₅₇ together are 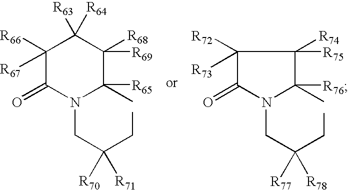
R₆₃, R₆₄, R₆₅, R₆₆, R₆₇, R₆₈, R₆₉, R₇₀, R₇₁, R₇₂, R₇₃, R₇₄, R₇₅, R₇₆, R₇₇ and R₇₈ are each independently of the others hydrogen or C₁-C₄alkyl;
   or to a compound of formula XV 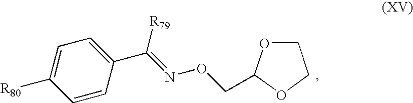
   wherein R₈₀ is hydrogen or chlorine and R₇₉ is cyano or trifluoromethyl;
   or to a compound of formula XVI 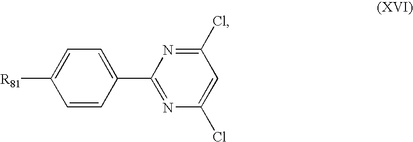
   wherein R₈₁ is hydrogen or methyl;
   or to a compound of formula XVII 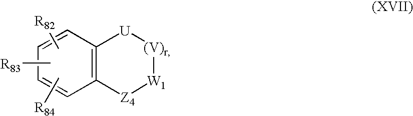
   wherein
R₈₂ is hydrogen, C₁-C₄alkyl or C₁-C₄alkyl substituted by C₁-C₄alkyl-X₂— or by C₁-C₄haloalkyl-X₂— or is C₁-C₄haloalkyl, nitro, cyano, —COOR₈₅, —NR₈₆R₈₇, —SO₂NR₈₈R₈₉ or —CONR₉₀R₉₁;
R₈₃ is hydrogen, halogen, C₁-C₄alkyl, trifluoromethyl, C₁-C₄alkoxy or C₁-C₄haloalkoxy;
R₈₄ is hydrogen, halogen or C₁-C₄alkyl;
U, V, W₁ and Z₄ are each independently of the others oxygen, sulfur, C(R₉₂)R₉₃, carbonyl, NR₉₄, a group 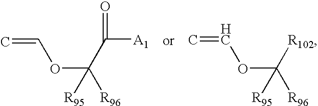
wherein R₁₀₂ is C₂-C₄alkenyl or C₂-C₄alkynyl; with the provisos that
a) at least one of the ring members U, V, W₁ or Z₄ is carbonyl, and a ring member adjacent to that or those ring member(s) is the group 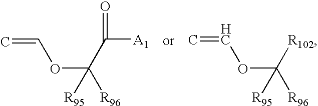
that group being present only once; and
b) two adjacent ring members U and V, V and W₁, and W₁ and Z₄ cannot simultaneously be oxygen;
R₉₅ and R₉₆ are each independently of the other hydrogen or C₁-C₈alkyl; or
R₉₅ and R₉₆ together form a C₂-C₆alkylene group;
A₁ is R₉₉—Y₁— or —NR₉₇R₉₈;
X₂ is oxygen or —S(O)₈;
Y₁ is oxygen or sulfur;
R₉₉ is hydrogen, C₁-C₈alkyl, C₁-C₈haloalkyl, C₁-C₄alkoxy-C₁-C₈alkyl, C₃-C₆alkenyloxy-C₁-C₈-alkyl or phenyl-C₁-C₈alkyl, it being possible for the phenyl ring to be substituted by halogen, C₁-C₄alkyl, trifluoromethyl, methoxy or by methyl-S(O)₈—, or is C₃-C₆alkenyl, C₃-C₆haloalkenyl, phenyl-C₃-C₆alkenyl, C₃-C₆alkynyl, phenyl-C₃-C₆alkynyl, oxetanyl, furyl or tetrahydrofuryl;
R₈₅ is hydrogen or C₁-C₄alkyl;
R₈₆ is hydrogen, C₁-C₄alkyl or C₁-C₄alkylcarbonyl;
R₈₇ is hydrogen or C₁-C₄alkyl; or
R₈₆ and R₈₇ together form a C₄- or C₅-alkylene group;
R₈₈, R₈₉, R₉₀ and R₉₁ are each independently of the others hydrogen or C₁-C₄alkyl; or R₈₈ together with R₈₉, or R₉₀ together with R₉₁, are, each pair independently of the other, C₄- or C₅-alkylene, it being possible for one carbon atom to have been replaced by oxygen or by sulfur, or for one or two carbon atoms to have been replaced by —NR₁₀₀—;
R₉₂, R₁₀₀ and R₉₃ are each independently of the others hydrogen or C₁-C₈alkyl; or
R₉₂ and R₉₃ together are C₂-C₆alkylene;
R₉₄ is hydrogen or C₁-C₈alkyl;
R₉₇ is hydrogen, C₁-C₈alkyl, phenyl or phenyl-C₁-C₈alkyl, it being possible for the phenyl rings to be substituted by fluorine, chlorine, bromine, nitro, cyano, —OCH₃, C₁-C₄alkyl or by CH₃SO₂—, or is C₁-C₄alkoxy-C₁-C₈alkyl, C₃-C₆alkenyl or C₃-C₆alkynyl;
R₉₈ is hydrogen, C₁-C₈alkyl, C₃-C₆alkenyl or C₃-C₆alkynyl; or
R₉₇ and R₉₈ together are C₄- or C₅-alkylene, it being possible for one carbon atom to have been replaced by oxygen or by sulfur, or for one or two carbon atoms to have been replaced by —NR₁₀₀—;
R₁₀₁ is hydrogen or C₁-C₄alkyl;
r is 0 or 1; and
s is 0, 1 or 2;
   or to a compound of formula XVIII 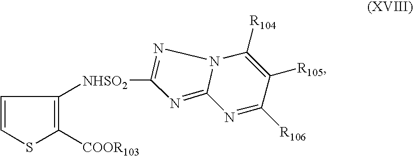
   wherein R₁₀₃ is hydrogen, C₁-C₆alkyl, C₃-C₆cycloalkyl, C₃-C₆alkenyl or C₃-C₆alkynyl; and R₁₀₄, R₁₀₅ and R₁₀₆ are each independently of the others hydrogen, C₁-C₆alkyl, C₃-C₆cycloalkyl or C₁-C₆alkoxy, with the proviso that one of the substituents R₁₀₄, R₁₀₅ and R₁₀₆ is other than hydrogen;
   or to a compound of formula XIX 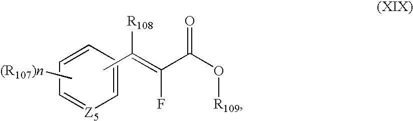
   wherein Z is N or CH, n is 0, 1, 2 or 3 when 4 is N, and n is 0, 1, 2, 3 or 4 when Z₅ is CH, R₁₀₇ is halogen, C₁-C₄alkyl, C₁-C₄haloalkyl, C₁-C₄alkoxy, C₁-C₄haloalkoxy, nitro, C₁-C₄alkylthio, C₁-C₄alkylsulfonyl, C₁-C₄alkoxycarbonyl, phenyl or phenoxy, or phenyl or phenoxy substituted by C₁-C₃alkyl, C₁-C₃haloalkyl, C₁₋₃alkoxy, C₁-C₃haloalkoxy, halogen, cyano or by nitro;
R₁₀₈ is hydrogen or C₁-C₄alkyl, R₁₀₉ is hydrogen, C₁-C₄alkyl, C₃-C₆cycloalkyl, C₂-C₆alkenyl, C₂-C₆alkynyl, C₁-C₄haloalkyl, C₂-C₆haloalkenyl, C₂-C₆haloalkynyl, C₁-C₄alkylthio-C₁-C₄alkyl, C₁-C₄alkylsulfonyl-C₁-C₄alkyl, C₁-C₄alkoxy-C₁-C₄alkyl, C₁-C₄alkenyloxy-C₁-C₄alkyl or C₁-C₄alkynyloxy-C₁-C₄alkyl;
   or to a compound of formula XX 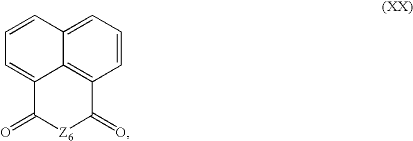
   wherein Z₆ is oxygen or N—R₁₁₀, and R₁₁₀ is a group of formula 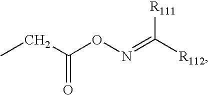
   wherein R₁₁₁ and R₁₁₂ are each independently of the other cyano, hydrogen, C₁-C₄alkyl, C₃-C₆cycloalkyl, C₂-C₆alkenyl, aryl, phenyl or heteroaryl, or phenyl, aryl or heteroaryl substituted by C₁-C₃alkyl, C₁-C₃haloalkyl, C₁-C₃alkoxy, C₁-C₃haloalkoxy, halogen, cyano or by nitro;
   or to a compound of formula XXI 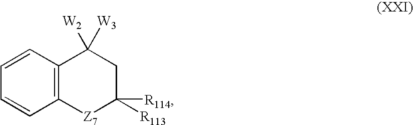
   wherein Z₇ is oxygen, sulfur, S═O, SO₂ or CH₂, R₁₁₃ and R₁₁₄ are each independently of the other hydrogen, halogen or C₁-C₄alkyl, W₂ and W₃ are each independently of the other CH₂COOR₁₁₅ or COOR₀₁₁₅ or together are a group of formula —(CH₂)C(O)—O—C(O)—(CH₂)—, and R₁₁₅ and R₀₁₁₅ are each independently of the other hydrogen, C₁-C₄alkyl, C₂-C₄alkenyl, C₂-C₆alkynyl, C₃-C₆cycloalkyl, C₁-C₄haloalkyl, a metal cation or an ammonium cation;
   or to a compound of formula XXII 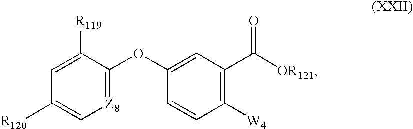
   wherein R₁₁₉ and R₁₂₀ are each independently of the other hydrogen, halogen or C₁-C₄haloalkyl, R₁₂₁ is hydrogen, C₁-C₄alkyl, C₃-C₄alkenyl, C₃-C₄alkynyl, C₁-C₄haloalkyl, C₃-C₆cycloalkyl, a metal cation or an ammonium cation, Z₆ is N, CH, C—F or C—Cl, and W₄ is a group of formula 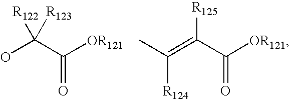
   wherein R₁₂₂ and R₁₂₃ are each independently of the other hydrogen or C₁-C₄alkyl, and R₁₂₄ and R₁₂₅ are each independently of the other hydrogen or C₁-C₄alkyl;
   or to a compound of formula XXIII 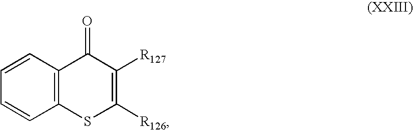
   wherein R₁₂₆ is hydrogen, cyano, halogen, C₁-C₄alkyl, C₃-C₆cycloalkyl, C₁-C₄alkoxy, C₁-C₄-alkoxycarbonyl, C₁-C₄alkylthiocarbonyl, —NH—R_{128,} —C(O)NH—R₀₁₂₈, aryl or heteroaryl, or aryl or heteroaryl substituted by C₁-C₃alkyl, C₁-C₃haloalkyl, C₁-C₃alkoxy, C₁-C₃haloalkoxy, halogen, cyano or by nitro;
R₁₂₇ is hydrogen, cyano, nitro, halogen, C₁-C₄alkyl, C₁-C₄haloalkyl, C₁-C₄alkoxy or C₁-C₄-thioalkyl, and
R₁₂₈ and R₀₁₂₈ are each independently of the other C₁-C₄alkyl, C₁-C₄haloalkyl, C₃-C₄alkenyl, C₃-C₄alkynyl, C₃-C₄cycloalkyl, aryl or heteroaryl, or aryl or heteroaryl substituted by C₁-C₃-alkyl, C₁-C₃haloalkyl, C₁-C₃alkoxy, C₁-C₃haloalkoxy, halogen, cyano or by nitro, formyl, C₁-C₄alkylcarbonyl or C₁-C₄alkylsulfonyl;
   or to a compound of formula XXIV 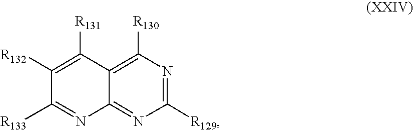
   wherein R₁₂₉ and R₁₃₀ are each independently of the other hydrogen, C₁-C₄alkyl, C₁-C₄haloalkyl, C₁-C₄alkoxy, mono-C₁-C₈- or di-C₁-C₈-alkylamino, C₃-C₆cycloalkyl, C₁-C₄thioalkyl, phenyl or heteroaryl, R₁₃₁ is as defined for R₁₂₉ and may, in addition, be OH, NH₂, halogen, di-C₁-C₄aminoalkyl, C₁-C₄alkylthio, C₁-C₄alkylsulfonyl or C₁-C₄alkoxycarbonyl, R₁₃₂ is as defined for R₁₂₉ and may, in addition, be cyano, nitro, carboxyl, C₁-C₄alkoxycarbonyl, di-C₁-C₄aminoalkyl, C₁-C₄alkylthio, C₁-C₄alkylsulfonyl, SO₂—OH, iso-C₁-C₄aminoalkylsulfonyl or C₁-C₄alkoxysulfonyl, R₁₃₃ is as defined for R₁₂₉ and may, in addition, be OH, NH₂, halogen, di-C₁-C₄aminoalkyl, pyrrolidin-1-yl, piperidin-1-yl, morpholin-1-yl, C₁-C₄alkylthio, C₁-C₄alkylsulfonyl, C₁-C₄alkoxycarbonyl, phenoxy, naphthoxy, phenylamino, benzoyloxy or phenylsulfonyloxy;
   or to a compound of formula XXV 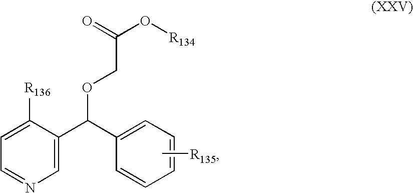
   wherein R₁₃₄ is hydrogen, C₄alkyl, C₁-C₄haloalkyl, C₂-C₄alkenyl, C₂-C₄alkynyl or C₁-C₄alkoxy-C₁-C₄alkyl, R₁₃₅ is hydrogen, halogen, C₁-C₄alkyl, C₁-C₄haloalkyl or C₁-C₄alkoxy and R₁₃₆ is hydrogen, halogen, C₁-C₄alkyl, C₁-C₄haloalkyl or C₁-C₄alkoxy, with the proviso that R₁₃₅ and R₁₃₆ are not simultaneously hydrogen,
   or to formula XXVI 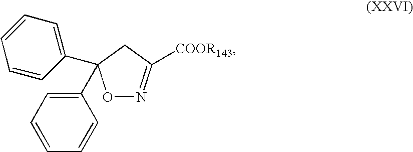
   wherein
R₁₄₃ is hydrogen, an alkali metal cation, alkaline earth metal cation, sulfonium cation or ammonium cation, or is ethyl;
   or to formula XXVII 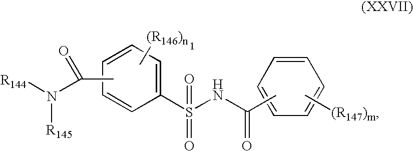
   wherein R₁₄₄ and R₁₄₅ are each independently of the other hydrogen, C₁-C₆alkyl, C₂-C₆-alkenyl, C₂-C₆alkynyl or C₃-C₆cycloalkyl;
R₁₄₆ is hydrogen, halogen, C₁-C₄alkyl, C₁-C₆haloalkyl or C₁-C₆haloalkoxy;
R₁₄₇ is hydrogen, halogen, C₁-C₄alkyl, C₁-C₄haloalkyl, C₁-C₄alkoxy, C₁-C₄haloalkoxy, C₁-C₄-alkylthio, C₁-C₄alkoxycarbonyl or nitro;
n₁ is 0, 1, 2 or 3; and
m is 1 or 2;
   or to formula XXVIII 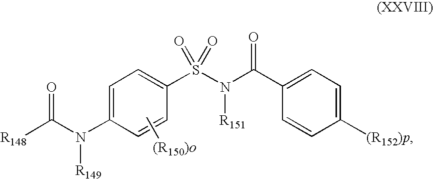
   wherein
R₁₄₈ is hydrogen, C₁-C₆alkyl, C₁₋₆alkoxy, C₁-C₆alkylthio, C₃-C₈cycloalkyl, phenyl, phenyl-C₁-C₆alkyl or heteroaryl; it being possible for the mentioned groups to be substituted by halogen, cyano, nitro, amino, hydroxy, carbonyl, carboxyl, formyl, carboxamide or by sulfonamide;
R₁₄₉ is hydrogen, C₁-C₆alkyl or C₁-C₄haloalkyl;
each R₁₅₀ is independently of any other hydrogen, halogen, C₁-C₄alkyl, C₁-C₄haloalkyl, C₁-C₄alkoxy, C₁-C₄alkylthio, C₁-C₄alkylsulfonyl, cyano, nitro, formyl or carboxyl;
R₁₅₁ is hydrogen, C₁-C₆alkyl or C₁-C₄haloalkyl;
each R₁₅₂ is independently of any other hydrogen, halogen, C₁-C₄alkyl, C₁-C₄haloalkyl, C₁-C₄alkoxy, C₁-C₄alkylthio, C₁-C₄alkylsulfonyl, cyano, nitro, formyl or carboxyl;
o is 0, 1 or 2, and
p is 0, 1 or 2;
   or to formula XXIX 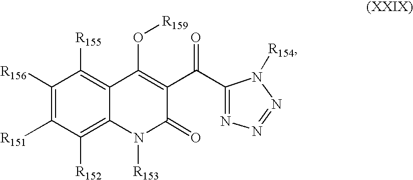
   wherein
R₁₅₉ is hydrogen, formyl, C₁₋₄alkylcarbonyl, C₁₋₄alkenylcarbonyl, C₁₋₆alkynylcarbonyl, C₁₋₆alkoxycarbonyl, C₁₋₆alkylthiocarbonyl, C₃₋₈cycloalkylcarbonyl, phenyl-C₁₋₆alkylcarbonyl, phenylcarbonyl, C₁₋₆alkylsulfonyl, C₁₋₆alkenylsulfonyl or phenylsulfonyl, it being possible for the afore-mentioned hydrocarbyl groups to be substituted by one or more halogen atoms, cyano, nitro, amino, methoxy, ethoxy or phenyl groups;
R₁₅₃ is hydrogen, C₁₋₆alkyl, C₁₋₆alkenyl, C₁₋₆alkynyl, C₃₋₈cycloalkyl, formyl, C₁₋₆alkylcarbonyl, C₁₋₆alkenylcarbonyl, C₁₋₄alkynylcarbonyl, C₁₋₆alkoxycarbonyl, C₁₋₆alkylthiocarbonyl, C₃₋₈cycloalkylcarbonyl, C₁₋₆alkylsulfonyl, C₁₋₄alkenylsulfonyl or phenylsulfonyl, it being possible for the afore-mentioned hydrocarbyl groups to be substituted by one or more halogen atoms, cyano, nitro, amino, methoxy, ethoxy or phenyl groups;
R₁₅₄ is hydrogen, C₁₋₆alkyl, C₁₋₆alkenyl, C₁₋₄alkynyl, C₃₋₈cycloalkyl, formyl, C₁₋₆alkylcarbonyl, C₁₋₆alkenylcarbonyl, C₁₋₆alkynylcarbonyl, C₁₋₄alkoxycarbonyl, C₁₋₆alkylthiocarbonyl, C₃₋₄cycloalkylcarbonyl, C₁₋₆alkylsulfonyl, C₁₋₆alkenylsulfonyl or phenylsulfonyl, it being possible for the afore-mentioned hydrocarbyl groups to be substituted by one or more halogen atoms, cyano, nitro, amino, methoxy, ethoxy or phenyl groups;
R₁₅₅, R₁₅₆, R₁₅₇ and R₁₅₈ are each independently of the others hydrogen, halogen, amino, C₁₋₃alkylamino, C₁₋₆dialkylamino, hydroxy, cyano, nitro, formyl, carboxyl, C₁₋₆alkoxy, C₁₋₆haloalkoxy, C₁₋₆alkylcarbonyl, C₁₋₆alkoxycarboxyl, C₁₋₆alkyl, C₁₋₆haloalkyl, C₁₋₆alkenyl or C₁₋₆alkynyl;
or R₁₅₃ and R₁₅₈, together with the ring atoms to which they are bonded, form a five- or six-membered, partially saturated or unsaturated ring which may contain up to 2 identical or different hetero atoms from the group oxygen, sulfur and nitrogen, it being possible for that ring to be substituted by an oxo radical.

The compositions according to the invention preferably comprise an amount, effective for herbicide antagonism, of a safener of formula X, XI, XII, XIII, XIV, XV, XVI, XVII, XVIII, XIX, XX, XXI, XXII, XXIII, XXIV or XXV.

The selectively herbicidal composition according to the invention especially comprises, in an amount effective for herbicide antagonism, either a compound of formula X 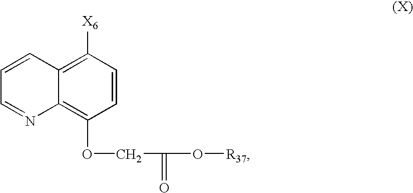
wherein R₃₇ is hydrogen, C₁-C₈alkyl, or C₁-C₈alkyl substituted by C₁-C₆alkoxy or by C₃-C₆-alkenyloxy; and X₆ is hydrogen or chlorine; or a compound of formula XI 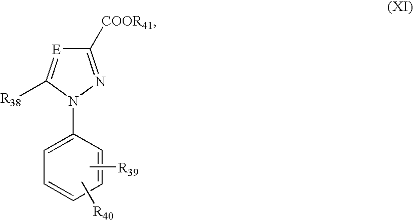
wherein
E is nitrogen or methine; R₃₈ is —CCl₃, phenyl or halo-substituted phenyl;
R₃₉ and R₄₀ are each independently of the other hydrogen or halogen; and
R₄₁, is C₁-C₄alkyl; or a compound of formula XII 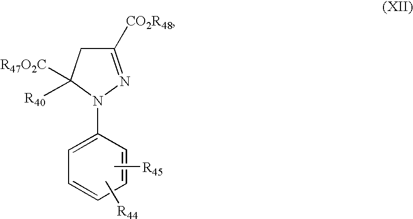
   wherein R₄₄ and R₄₅ are each independently of the other hydrogen or halogen, and
R₄₆, R₄₇ and R₄₈ are each independently of the others C₁-C₄alkyl.

The preferred meanings mentioned hereinbefore for the compounds of formula I also apply in the case of mixtures of compounds of formula I with safeners of formulae X to XVIII. Preferred compositions according to the invention comprise a safener selected from the group of formula Xa 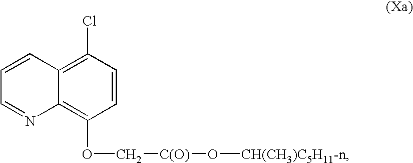
formula Xb 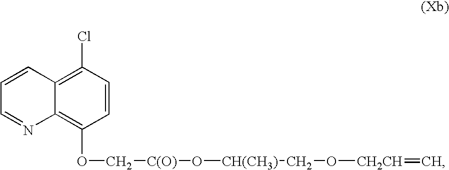
and formula XIa

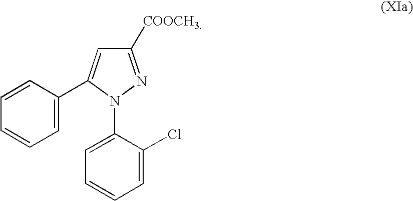

Further preferred compounds of formulae X, XI and XII are also listed in Tables 9, 10 and 11.

TABLE 9
Compounds of formula X:

| | |
|---|---|
| 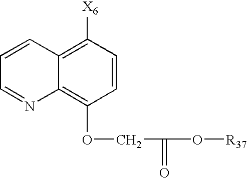 | (X) |

| Comp. no. | X₆ | R₃₇ |
|---|---|---|
| 9.01 | Cl | —CH(CH₃)—C₅H₁₁₋ₙ |
| 9.02 | Cl | —CH(CH₃)—CH₂OCH₂CH═CH₂ |
| 9.03 | Cl | H |
| 9.04 | Cl | C₄H₉-n |

Preferred compounds of formula XI are listed in the following Table 10.

TABLE 10
Compounds of formula XI:

| | |
|---|---|
| 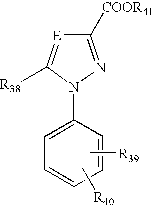 | (XI) |

| Comp. no. | R₄₁ | R₃₈ | R₃₉ | R₄₀ | E |
|---|---|---|---|---|---|
| 10.01 | CH₃ | phenyl | 2-Cl | H | CH |
| 10.02 | CH₃ | phenyl | 2-Cl | 4-Cl | CH |
| 10.03 | CH₃ | phenyl | 2-F | H | CH |
| 10.04 | CH₃ | 2-chlorophenyl | 2-F | H | CH |
| 10.05 | C₂H₅ | CCl₃ | 2-Cl | 4-Cl | N |
| 10.06 | CH₃ | phenyl | 2-Cl | 4-CF₃ | N |
| 10.07 | CH₃ | phenyl | 2-Cl | 4-CF₃ | N |

Preferred compounds of formula XII are listed in the following Table 11.

TABLE 11
Compounds of formula XII:

| | |
|---|---|
| 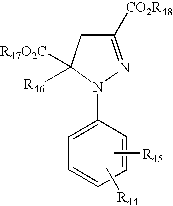 | (XII) |

| Comp. no. | R₄₆ | R₄₇ | R₄₈ | R₄₄ | R₄₅ |
|---|---|---|---|---|---|
| 11.01 | CH₃ | CH₃ | CH₃ | 2-Cl | 4-Cl |
| 11.02 | CH₃ | C₂H₅ | CH₃ | 2-Cl | 4-Cl |
| 11.03 | CH₃ | C₂H₅ | C₂H₅ | 2-Cl | 4-Cl |

Preferred compounds of formula XIII are listed in the following Table 12 as compounds of formula XIIIa:

TABLE 12
Compounds of formula XIIIa:

| | |
|---|---|
| 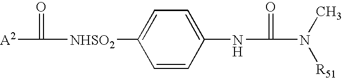 | (XIIIa) |

| Comp. no. | A₂ | R₅₁ |
|---|---|---|
| 12.001 | 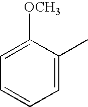 | H |
| 12.002 | 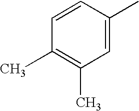 | H |
| 12.003 | 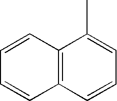 | CH₃ |
| 12.004 | 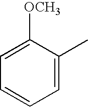 | CH₃ |

Preferred compounds of formula XIV are listed in the following Table 13:

TABLE 13
Compounds of formula XIV:

| | |
|---|---|
| 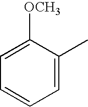 | (XIV) |

| Comp. no. | R₅₆ | R₅₇ | R₅₆ + R₅₇ |
|---|---|---|---|
| 13.001 | CH₂═CHCH₂ | CH₂═CHCH₂ | — |
| 13.002 | — | — | 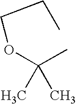 |
| 13.003 | — | — | 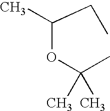 |
| 13.004 | — | — | 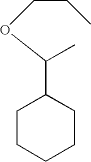 |
| 13.005 | — | — | 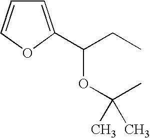 |
| 13.006 | — | — | 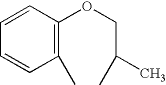 |
| 13.007 | — | — | 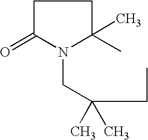 |
| 13.008 | — | — | 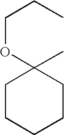 |

Preferred compounds of formula XV are listed in the following Table 14:

TABLE 14
Compounds of formula XV:

| | |
|---|---|
| 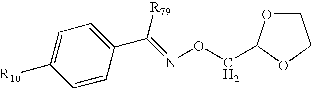 | (XV) |

| Comp. no. | R₈₀ | R₇₉ |
|---|---|---|
| 14.01 | H | CN |
| 14.02 | Cl | CF₃ |

Preferred compounds of formula XVI are listed in the following Table 15:

TABLE 15
Compounds of formula XVI:

| | |
|---|---|
| 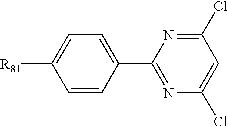 | (XVI) |

| Comp. no. | R₈₁ |
|---|---|
| 15.01 | H |
| 15.02 | CH₃ |

Preferred compounds of formula XVII are listed in the following Table 16 as compounds of formula XVIIa:

TABLE 16
Compounds of formula XVIIa

| | |
|---|---|
| 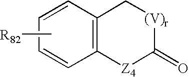 | (XVIIa) |

| Comp. | | | | |
|---|---|---|---|---|
| no. | R₈₂ | Z₄ | V | r |
| 16.001 | H | 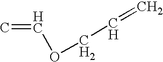 | O | 1 |
| 16.002 | H | 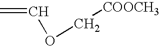 | O | 1 |
| 16.003 | H | 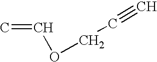 | O | 1 |
| 16.004 | H | 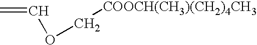 | O | 1 |
| 16.005 | H | 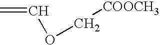 | CH₂ | 1 |
| 16.006 | H | 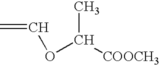 | CH₂ | 1 |
| 16.007 | H | 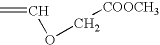 | S | 1 |
| 16.008 | H | 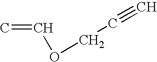 | S | 1 |
| 18.009 | H | 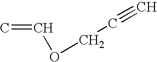 | NCH₃ | 1 |
| 16.010 | H | 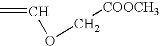 | NCH₃ | 1 |
| 16.011 | H | 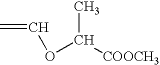 | NCH₃ | 1 |
| 16.012 | H | 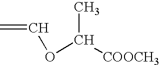 | O | 1 |
| 16.013 | H | 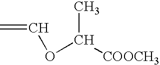 | S | 1 |

Preferred compounds of formula XVII are listed in the following Table 17 as compounds of formula XVIIb:

TABLE 17
Compounds of formula XVIIb

| | |
|---|---|
| 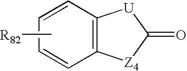 | (XVIIb) |

| Comp. no. | U | R₈₂ | Z₄ |
|---|---|---|---|
| 17.001 | O | H | 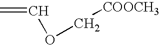 |
| 17.002 | O | H | 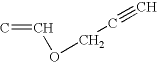 |
| 17.003 | O | 5-Cl | 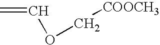 |
| 17.004 | CH₂ | H | 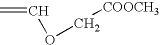 |
| 17.005 | CH₂ | H | 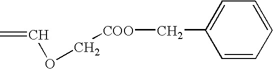 |
| 17.006 | CH₂ | H | 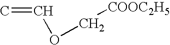 |
| 17.007 | NH | 5-Cl | 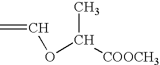 |
| 17.008 | NH | 5-Cl | 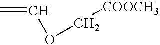 |
| 17.009 | NH | H | 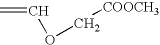 |
| 17.010 | NH | H | 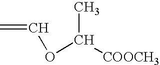 |
| 17.011 | NCH₃ | H | 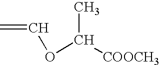 |
| 17.012 | NCH₃ | H | 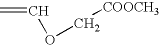 |

Preferred compounds of formula XVII are listed in the following Table 18 as compounds of formula XVIIc:

TABLE 18
Compounds of formula XVIIc

| | |
|---|---|
| 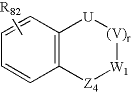 | (XVIIc) |

| Comp. no. | U | V | r | W₁ | Z₄ | R₈₂ |
|---|---|---|---|---|---|---|
| 18.001 | O | C═O | 1 | 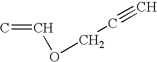 | CH₂ | H |
| 18.002 | O | C═O | 1 | 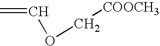 | CH₂ | H |
| 18.003 | CH₂ | C═O | 1 | 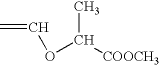 | CH₂ | H |
| 18.004 | CH₂ | C═O | 1 | 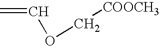 | CH₂ | H |
| 18.005 | CH₂ | CH₂ | 1 | 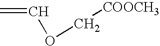 | C═O | H |
| 18.006 | CH₂ | CH₂ | 1 | 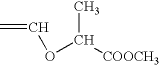 | C═O | H |
| 18.007 | NCH₃ | C═O | 1 | 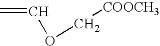 | CH₂ | H |

Preferred compounds of formula XVII are listed in the following Table 19 as compounds of formula XVIId:

TABLE 19
Compounds of formula XVIId

| | |
|---|---|
| | (XVIId) |
| 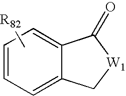 | |

| Comp. no. | R₈₂ | W₁ |
|---|---|---|
| 19.001 | 6-Cl | 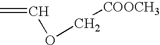 |
| 19.002 | 6-Cl | 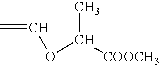 |
| 19.003 | H | 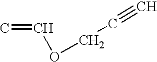 |
| 19.004 | H | 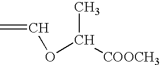 |
| 19.005 | H | 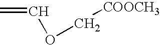 |

Preferred compounds of formula XVIII are listed in the following Table 20:

TABLE 20
Compounds of formula XVII

| | |
|---|---|
| | (XVIII) |
| 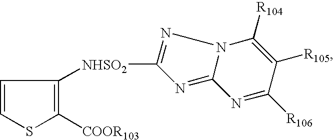 | |

| Comp. no. | R₁₀₃ | R₁₀₄ | R₁₀₅ | R₁₀₆ |
|---|---|---|---|---|
| 20.01 | CH₃ | H | cyclopropyl | H |
| 20.02 | CH₃ | C₂H₅ | cyclopropyl | H |
| 20.03 | CH₃ | cyclopropyl | C₂H₅ | H |
| 20.04 | CH₃ | CH₃ | H | H |
| 20.05 | CH₃ | CH₃ | cyclopropyl | H |
| 20.06 | CH₃ | OCH₃ | OCH₃ | H |
| 20.07 | CH₃ | CH₃ | OCH₃ | H |
| 20.08 | CH₃ | OCH₃ | CH₃ | H |
| 20.09 | CH₃ | CH₃ | CH₃ | H |
| 20.10 | C₂H₅ | CH₃ | CH₃ | H |
| 20.11 | C₂H₅ | OCH₃ | OCH₃ | H |
| 20.12 | H | OCH₃ | OCH₃ | H |
| 20.13 | H | CH₃ | CH₃ | H |
| 20.14 | C₂H₅ | H | H | CH₃ |
| 20.15 | H | H | H | CH₃ |
| 20.16 | CH₃ | H | H | CH₃ |
| 20.17 | CH₃ | CH₃ | H | CH₃ |

Among the compounds of formula XXVIII preference is given to those wherein
R₁₄₈ is hydrogen, C₁-C₆alkyl, C₃-C₈cycloalkyl or phenyl, it being possible for the mentioned groups to be substituted by halogen, cyano, nitro, amino, hydroxy, carbonyl, carboxyl, formyl, carboxamide or by sulfonamide;
R₁₄₉ is hydrogen;
each R₁₅₀ is, independently of any other, hydrogen, halogen, C₁-C₄alkyl, C₁-C₄haloalkyl, C₁-C₄alkoxy, C₁-C₄alkylthio, cyano, nitro or formyl;
R₁₅₁ is hydrogen; and
each R₁₅₂ is, independently of any other, hydrogen, halogen, C₁-C₄alkyl, C₁-C₄haloalkyl, C₁-C₄alkoxy, C₁-C₄alkylthio, cyano, nitro or formyl.

Especially preferred compounds of formula XXVIII are selected from the group
2-methoxy-N-[4-(2-methoxybenzoylsulfamoyl)phenyl]acetamide,
N-[4-(2-methoxybenzoylsulfamoyl)phenyl]cyclopropanecarboxamide,
N-[4-(2-methoxybenzoylsulfamoyl)phenyl]cyclobutanecarboxamide,
N-[4-(2-chlorobenzoylsulfamoyl)phenyl]cyclopropanecarboxamide,
N-[4-(2-chlorobenzoylsulfamoyl)phenyl]acetamide,
N-[4-(2-trifluoromethoxybenzoylsulfamoyl)phenyl]acetamide,
N-[4-(2-trifluoromethylbenzoylsulfamoyl)phenyl]cyclopropanecarboxamide,
N-[4-(2-trifluoromethoxybenzoylsulfamoyl)phenyl]cyclopropanecarboxamide,
N-[4-(2-trifluoromethoxybenzoylsulfamoyl)phenyl]cyclobutanecarboxamide and
N-[4-(2-trifluoromethylbenzoylsulfamoyl)phenyl]acetamide.

Among the compounds of formula XXIX preference is given to those wherein
R₁₅₉ is hydrogen, formyl, C₁₋₆alkylcarbonyl, C₁₋₆alkenylcarbonyl, C₁₋₆alkynylcarbonyl, C₁₋₆alkoxycarbonyl, C₁₋₆alkylthiocarbonyl, C₃₋₈cycloalkylcarbonyl, phenyl-C₁₋₆alkylcarbonyl or phenylcarbonyl, it being possible for the afore-mentioned hydrocarbyl radicals to be substituted by one or more halogen atoms, cyano, nitro, amino, methoxy, ethoxy or phenyl groups;
R₁₅₃ is hydrogen, C₁₋₆alkyl, C₁₋₆alkenyl, C₁₋₆alkynyl, formyl, C₁₋₆alkylcarbonyl or C₁₋₆alkoxycarbonyl, it being possible for the afore-mentioned hydrocarbyl radicals to be substituted by one or more halogen atoms, cyano, nitro, amino, methoxy, ethoxy or phenyl groups;
R₁₅₄ is hydrogen, C₁₋₆alkyl, C₁₋₆alkenyl, C₁₋₆alkynyl, formyl, C₁₋₆alkylcarbonyl or C₁₋₆alkoxycarbonyl, it being possible for the afore-mentioned hydrocarbyl radicals to be substituted by one or more halogen atoms, cyano, nitro, amino, methoxy, ethoxy or phenyl groups;
R₁₅₅, R₁₅₆, R₁₅₇ and R₁₅₈ are each independently of the others hydrogen, halogen, cyano, nitro, formyl, carboxyl, C₁₋₆alkoxy, C₁₋₆haloalkoxy, C₁₋₆alkylcarbonyl, C₁₋₆alkoxycarboxyl, C₁₋₆alkyl or C₁₋₆₆haloalkyl;
or R₁₅₃ and R₁₅₈, together with the ring atoms to which they are bonded, form a five- or six-membered, partially saturated or unsaturated ring which may contain up to 2 identical or different hetero atoms from the group oxygen, sulfur and nitrogen, it being possible for that ring to be substituted by an oxo radical.

Special preference is given to compounds of formula XXIX wherein
R₁₅₉ is hydrogen, formyl, C₁₋₆alkylcarbonyl, C₁₋₆alkenylcarbonyl, C₁₋₆alkynylcarbonyl, C₁₋₆alkoxycarbonyl, C₁₋₆alkylthiocarbonyl, C₃₋₈cycloalkylcarbonyl or phenylcarbonyl;
R₁₅₃ is hydrogen, C₁₋₆alkyl, C₁₋₆alkenyl, C₁₋₆alkynyl, formyl, C₁₋₆alkylcarbonyl or C₁₋₆alkoxycarbonyl;
R₁₅₄ is hydrogen, C₁₋₆alkyl, C₁₋₆alkenyl, C₁₋₆alkynyl, formyl, C₁₋₆alkylcarbonyl or C₁₋₆alkoxycarbonyl;
R₁₅₅, R₁₅₆, R₁₅₇ and R₁₅₈ are each independently of the others hydrogen, halogen, cyano, nitro, formyl, C₁₋₆alkyl, C₁₋₆haloalkyl, C₁₋₆alkoxy or C₁₋₆haloalkoxy;
or R₁₅₃ and R₁₅₈, together with the ring atoms to which they are bonded, form a five- or six-membered, partially saturated or unsaturated ring which may contain up to 2 identical or different hetero atoms from the group oxygen, sulfur and nitrogen, it being possible for that ring to be substituted by an oxo radical.

Very especially preferred compounds of formula XXIX are selected from the group:
4-hydroxy-1-methyl-3-(1H-tetrazol-5-carbonyl)-1H-quinolin-2-one,
1-ethyl-4-hydroxy-3-(1H-tetrazol-5-carbonyl)-1H-quinolin-2-one,
6-hydroxy-5-(1H-tetrazol-5-carbonyl)-1,2-dihydro-pyrrolo[3,2,1-.ij.]quinolin-4-one,
3-(1-acetyl-1H-tetrazol-5-carbonyl)hydroxy-1-methyl-1H-quinolin-2-one,
6-chloro-4-hydroxy-1-methyl-3-(1H-tetrazol-5-carbonyl)-1H-quinolin-2-one,
6-fluoro-4-hydroxy-1-methyl-3-(1H-tetrazol-5-carbonyl)-1H-quinolin-2-one,
4-hydroxy-1,6-dimethyl-3-(1H-tetrazol-5-carbonyl)-1H-quinolin-2-one,
4-hydroxy-6-methoxy-1-methyl-3-(1H-tetrazol-5-carbonyl)-1H-quinolin-2-one,
4-hydroxy-6-methoxy-1-methyl-3-(1H-tetrazole-5-carbonyl)-1H-quinolin-2-one,
acetic acid 1-methyl-2-oxo-3-(1H-tetrazol-5-carbonyl)-1,2-dihydro-quinolin-4-yl ester and
2,2-dimethyl-propionic acid 1-methyl-2-oxo-3-(1H-tetrazol-5-carbonyl)-1,2-dihydro-quinolin-4-yl ester.

The invention relates also to a method of selectively controlling weeds in crops of useful plants, which comprises treating the useful plants, seeds or cuttings thereof, or the area of cultivation thereof, simultaneously or separately with a herbicidally effective amount of a herbicide of formula I and an amount, effective for herbicide antagonism, of a safener of formula X, XI, XII, XIII, XIV, XV, XVI, XVII, XVIII, XIX, XX, XXI, XXII, XXIII, XXIV, XXV, XXVI, XXVII, XXVIII or XXIX, preferably of formula X, XI, XII, XIII, XIV, XV, XVI, XVII or XVIII.

The weeds to be controlled may be either monocotyledonous or dicotyledonous weeds, such as, for example, the monocotyledonous weeds Avena, Agrostis, Phalaris, Lolium, Bromus, Alopecurus, Setaria, Digitaria, Brachiaria, Echinochloa, Panicum, Sorghum hal./bic., Rottboellia, Cyperus, Brachiaria, Echinochloa, Scirpus, Monochoria, Sagittaria and Stellaria, and the dicotyledonous weeds Sinapis, Chenopodium, Galium, Viola, Veronica, Matricaria, Papaver, Solanum, Abutilon, Sida, Xanthium, Amaranthus, Ipomoea and Chrysanthemum. Areas of cultivation include land on which the crop plants are already growing or which has been sown with the seeds of those crop plants, as well as land intended for the cultivation of such crop plants.

Depending on the intended use, a safener of formula X, XI, XII, XII, XIV, XV, XVI, XVII, XVIII, XIX, XX, XXI, XXII, XXIII, XXIV, XXV, XXVI, XXVII, XXVIII or XXIX can be used in the pretreatment of the seed of the crop plant (dressing of the seeds or cuttings) or can be introduced into the soil before or after sowing. It can, however, also be applied, either alone or together with the herbicide, after emergence of the plants. The treatment of the plants or seeds with the safener can therefore in principle be carried out independently of the time at which the herbicide is applied. The plants can, however, also be treated by simultaneous application of herbicide and safener (e.g. in the form of a tank mixture). The ratio of the rate of application of safener to the rate of application of herbicide depends largely on the method of application. In the case of field treatment, which is carried out either using a tank mixture comprising a combination of safener and herbicide or by separate application of safener and herbicide, the ratio of herbicide to safener is generally from 100:1 to 1:10, preferably from 20:1 to 1:1. In the case of field treatment it is usual to apply from 0.001 to 1.0 kg of safener/ha, preferably from 0.001 to 0.25 kg of safener/ha.

The rate of application of herbicide is generally from 0.001 to 2 kg/ha, but preferably from 0.005 to 0.5 kg/ha.

The compositions according to the invention are suitable for all methods of application conventionally used in agriculture, e.g. pre-emergence application, post-emergence application and seed dressing.

In the case of seed dressing, generally from 0.001 to 10 g of safener/kg of seed, preferably from 0.05 to 2 g of safener/kg of seed, are applied. When the safener is applied in liquid form shortly before sowing, with soaking of the seeds, then advantageously the safener solutions used contain the active ingredient in a concentration of from 1 to 10 000 ppm, preferably from 100 to 1000 ppm.

For the purpose of application, the safeners of formula X, XI, XII, XIII, XIV, XV, XVI, XVII, XVIII, XIX, XX, XXI, XXII, XXIII, XXIV, XXV, XXVI, XXVII, XXVIII or XXIX or combinations of those safeners with a herbicide of formula I are advantageously formulated together with adjuvants customary in formulation technology, e.g. into emulsifiable concentrates, coatable pastes, directly sprayable or dilutable solutions, dilute emulsions, wettable powders, soluble powders, dusts, granules or microcapsules.

Such formulations are described, for example, in WO 97/34485, pages 9 to 13. The formulations are prepared in known manner, e.g. by intimately mixing and/or grinding the active ingredients with liquid or solid formulation adjuvants, e.g. solvents or solid carriers. In addition, surface-active compounds (surfactants) can also be used in the preparation of the formulations. Solvents and solid carriers suitable for that purpose are mentioned, for example, in WO 97/34485, page 6.

Depending on the nature of the compound of formula I to be formulated, there come into consideration as surface-active compounds non-ionic, cationic and/or anionic surfactants and surfactant mixtures having good emulsifying, dispersing and wetting properties. Examples of suitable anionic, non-ionic and cationic surfactants are listed, for example, on pages 7 and 8 of WO 97/34485. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol. I-III, Chemical Publishing Co., New York, 1980-81.

The herbicidal formulations usually contain from 0.1 to 99% by weight, especially from 0.1 to 95% by weight, of active ingredient mixture comprising the compound of formula I and a compound of formula X, XI, XII, XIII, XIV, XV, XVI, XVII, XVIII, XIX, XX, XXI, XXII, XXIII, XXIV, XXV, XXVI, XXVII, XXVIII or XXIX, from 1 to 99.9% by weight of a solid or liquid formulation adjuvant and from 0 to 25% by weight, especially from 0.1 to 25% by weight, of a surfactant. Whereas commercial products are usually formulated as concentrates, the end user will normally employ dilute formulations.

The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. For the use of safeners of formula X, XI, XII, XIII, XIV, XV, XVI, XVII, XVIII, XIX, XX, XXI, XXII, XXIII, XXIV, XXV, XXVI, XXVII, XXVIII or XXIX or of compositions comprising them, in the protection of crop plants against the damaging effects of herbicides of formula I, various methods and techniques come into consideration, such as, for example, the following:

i) Seed Dressing

a) Dressing of the seeds with a wettable powder formulation of a compound of formula X, XI, XII, XIII, XIV, XV, XVI, XVII, XVIII, XIX, XX, XXI, XXII, XXIII, XXIV, XXV, XXVI, XXVII, XXVIII or XXIX by shaking in a vessel until uniformly distributed over the seed surface (dry dressing). In that procedure approximately from 1 to 500 g of compound of formula X, XI, XII, XIII, XIV, XV, XVI, XVII, XVIII, XIX, XX, XXI, XXII, XXIII, XXIV, XXV, XXVI, XXVII, XXVIII or XXIX (4 g to 2 kg of wettable powder) are used per 100 kg of seed.
b) Dressing of the seeds with an emulsifiable concentrate of a compound of formula X, XI, XII, XIII, XIV, XV, XVI, XVII, XVIII, XIX, XX, XXI, XXII, XXIII, XXIV, XXV, XXVI, XXVII, XXVIII or XXIX according to method a) (wet dressing).
c) Dressing by immersing the seeds for from 1 to 72 hours in a liquor comprising from 100 to 1000 ppm of a compound of formula X, XI, XII, XIII, XIV, XV, XVI, XVII, XVIII, XIX, XX, XXI, XXII, XXIII, XXIV, XXV, XXVI, XXVII, XXVIII or XXIX and optionally subsequently drying the seeds (immersion dressing).

Dressing the seed or treating the germinated seedling are naturally the preferred methods of application, because treatment with the active ingredients is directed entirely at the target crop. Generally from 1 to 1000 g of antidote, preferably from 5 to 250 g of antidote, are used per 100 kg of seed, but depending on the methodology, which also allows other active ingredients or micronutrients to be added, concentrations above or below the limits indicated may be employed (repeat dressing).

ii) Application as a Tank Mixture

A liquid formulation of a mixture of antidote and herbicide is used (ratio by weight of the one to the other from 10:1 to 1:100), the rate of application of herbicide being from 0.005 to 5.0 kg per hectare. Such tank mixtures are applied before or after sowing.

iii) Application to the Seed Furrow

The compound of formula X, XI, XII, XIII, XIV, XV, XVI, XVII, XVIII, XIX, XX, XXI, XXII, XXIII, XXIV, XXV, XXVI, XXVII, XXVIII or XXIX is introduced into the open, sown seed furrow in the form of an emulsifiable concentrate, wettable powder or granules. Once the seed furrow has been covered over, the herbicide is applied in the usual manner pre-emergence.

iv) Controlled Release of Active Ingredient

The compound of formula X, XI, XII, XIII, XIV, XV, XVI, XVII, XVIII, XIX, XX, XXI, XXII, XXIII, XXIV, XXV, XXVI, XXVII, XXVIII or XXIX is applied in solution to mineral carrier granules or polymerised granules (urea/formaldehyde) and dried. If desired, it is also possible to apply a coating that allows the active ingredient to be released in metered amounts over a specific period of time (coated granules).

The activity of herbicidal and plant-growth-inhibiting compositions according to the invention containing a herbicidally effective amount of compound of formula I and an amount, effective for herbicide antagonism, of a compound of formula X, XI, XII, XIII, XIV, XV, XVI, XVII, XVIII, XIX, XX, XXI, XXII, XXIII, XXIV, XXV, XXVI, XXVII, XXVIII or XXIX can be increased, as mentioned hereinbefore, by adding spray tank adjuvants.

Preferred formulations have especially the following compositions:

(%=percent by weight)

| | | |
|---|---|---|
| Emulsifiable concentrates: | | |
| active ingredient mixture: | 1 to 90%, | preferably 5 to 20% |
| surface-active agent: | 1 to 30%, | preferably 10 to 20% |
| liquid carrier: | 5 to 94%, | preferably 70 to 85% |
| Dusts: | | |
| active ingredient mixture: | 0.1 to 10%, | preferably 0.1 to 5% |
| solid carrier: | 99.9 to 90%, | preferably 99.9 to 99% |
| Suspension concentrates: | | |
| active ingredient mixture: | 5 to 75%, | preferably 10 to 50% |
| water: | 94 to 24%, | preferably 88 to 30% |
| surface-active agent: | 1 to 40%, | preferably 2 to 30% |
| Wettable powders: | | |
| active ingredient mixture: | 0.5 to 90%, | preferably 1 to 80% |
| surface-active agent: | 0.5 to 20%, | preferably 1 to 15% |
| solid carrier: | 5 to 95%, | preferably 15 to 90% |
| Granules: | | |
| active ingredient mixture: | 0.1 to 30%, | preferably 0.1 to 15% |
| solid carrier: | 99.5 to 70%, | preferably 97 to 85% |

The following Examples illustrate the invention further, but do not limit the invention.

### FORMULATION EXAMPLES FOR MIXTURES OF HERBICIDES OF FORMULA I AND SAFENERS OF FORMULA X, XI, XII, XIII, XIV, XV, XVI, XVII, XVIII, XIX, XX, XXI, XXII, XXIII, XXIV, XXV, XXVI, XXVII, XXVIII OR XXIX (%=PERCENT BY WEIGHT)

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compound of formula I and the mixing partner of formula X, XI, XII, XIII, XIV, XV, XVI, XVII, XVIII, XIX, XX, XXI, XXII, XXIII, XXIV, XXV, XXVI, XXVII, XXVIII or XXIX to be formulated separately and then to be brought together in the desired mixing ratio in the applicator in the form of a “tank mixture” in water shortly before application.

The compound of formula I may advantageously be mixed with a plurality of further known herbicides, thereby resulting in a substantial broadening of the spectrum of weeds and also, in many cases, an increase in selectivity with respect to the useful plants. In particular, the mixtures of a compound of formula I with at least one of the following herbicides are of importance:
herbicides from the class of phenoxy-phenoxypropionic acids such as, for example, diclofopmethyl, fluazifop-P-butyl, quizalafop-P-ethyl, propaquizafop, clodinafop-P-propargyl, cyhalofop-butyl, fenoxaprop-P-ethyl, haloxyfop-methyl or haloxyfop-etotyl;
herbicides from the class of hydroxylamines such as, for example, sethoxydim, alloxydim, clethodim, cycloxydim, tepraloxydim, tralkoxydim or butroxydim;
herbicides from the class of sulfonylureas such as, for example, amidosulfuron, azimsulfuron, bensulfuron-methyl, chlorimuron-ethyl, cinosulfuron, chlorsulfuron, chlorimuron, cyclosulfamuron, ethametsulfuron-methyl, ethoxysulfuron, fluazasulfuron, flupyrsulfuron, imazosulfuron, iodosulfuron (CAS RN 144550-36-7 and 185119-76-0), metsulfuron-methyl, nicosulfuron, oxasulfuron, primisulfuron, pyrazosulfuron-ethyl, sulfosulfuron, rimsulfuron, thifensulfuron-methyl, triasulfuron, tribenuron-methyl, triflusulfuron-methyl, prosulfuron, flucarbazone or tritosulfuron (CAS RN 142469-14-5);
herbicides from the class of imidazolinones such as imazethapyr, imazamethabenz, imazamethapyr, imazaquin, imazamox or imazapyr;
herbicides from the class of pyrimidines such as pyrithiobac-sodium, pyriminobac, bispyribac-sodium;
herbicides from the class of triazines such as, for example, atrazine, simazine, simetryn, terbutryn, terbuthylazine;
herbicides from the class of ureas such as isoproturon, chlorotoluron, diuron, dymron, fluometuron, linuron or methabenzthiazuron;
herbicides from the class of phosphonic acid derivatives such as, for example, glyphosate, glufosinate, sulfosate or phosphinothricin;
herbicides from the class of PPO compounds such as, for example, nitrofen, bifenox, acifluorfen, lactofen, oxyfluorfen, ethoxyfen, fluoroglycofen, fomesafen, halosafen, azafenidin (CAS RN 68049-83-2), benzfendizone (CAS RN 158755-95-4), butafenacil (known from U.S. Pat. No. 5,183,492, CAS RN 158755-95-4), carfentrazone-ethyl, cinidon-ethyl (CAS RN 142891-20-1), flumiclorac-pentyl, flumioxazin, fluthiacet-methyl, oxadiargyl, oxadiazon, pentoxazone, sulfentrazone, fluazolate (CAS RN 174514-07-9) or pyraflufen-ethyl;
herbicides from the class of chloroacetanilides such as, for example, alachlor, acetochlor, butachlor, dimethachlor, dimethenamid, S-dimethenamid, metazachlor, metolachlor, S-metolachlor, pretilachlor, propachlor, propisochlor, thenylchlor or pethoxamid (CAS RN 106700-29-2)
herbicides from the class of phenoxyacetic acids such as, for example, 2,4-D, fluroxypyr, MCPA, MCPP, MCPB, triclopyr or mecoprop-P;
herbicides from the class of triazinones such as, for example, hexazinone, metamitron or metribuzin;
herbicides from the class of dinitroanilines such as, for example, oryzalin, pendimethalin or trifluralin;
herbicides from the class of azinones such as, for example, chloridazon or norflurazon;
herbicides from the class of carbamates such as, for example, chlorpropham, desmedipham, phenmedipham or propham;
herbicides from the class of oxyacetamides such as, for example, mefenacet or fluthiacet;
herbicides from the class of thiocarbamates such as, for example, butylate, cycloate, diallate, EPTC, esprocarb, molinate, prosulfocarb, thiobencarb or triallate;
herbicides from the class of azoloureas such as, for example, fentrazamide (CAS RN 158237-07-1) or cafenstrole;
herbicides from the class of benzoic acids such as, for example, dicamba or picloram;
herbicides from the class of anilides such as, for example, diflufenican or propanil;
herbicides from the class of nitriles such as, for example, bromoxynil, dichlobenil or ioxynil;
herbicides from the class of triones such as, for example, sulcotrione, mesotrione (known from U.S. Pat. No. 5,006,158), isoxaflutole or isoxachlortole;
herbicides from the class of sulfonamides such as, for example, flucarbazone (CAS RN 181274-17-9), procarbazone (CAS RN 145026-81-9), cloransulam, diclosulam (CAS RN 145701-21-9), florasulam, flumetsulam or metosulam;
and also amitrole, benfuresate, bentazone, cinmethylin, clomazone, clopyralid, difenzoquat, dithiopyr, ethofumesate, flurochloridone, indanofan, isoxaben, oxaziclomefone, pyridate, pyridafol (CAS RN 40020-01-7), quinclorac, quinmerac, tridiphane or flamprop, amicarbazone, benfluamid, benzobicyclon, flufenacet, flufenpyr, foramsulfuron, indanofan, mesosulfuron, oxaziclomefone, penoxsulam, pethoxamid, picolinafen, profluazol, profoxydim, propoxycarbazone, pyraflufen, pyrazogyl, sulfosulfuron, tepraloxydim or tritosulfuron.

Unless otherwise indicated, the above-mentioned mixing partners for the compound of formula I are known from The Pesticide Manual, Eleventh Edition, 1997, BCPC. The mixing partners for the compound of formula I can also be present, where appropriate, in the form of esters or salts, for example as mentioned in The Pesticide Manual, Eleventh Edition, 1997, BCPC.

The following Examples illustrate the invention further, but do not limit the invention.

### PREPARATION EXAMPLES

### Example P1

### Preparation of Compound 1.01

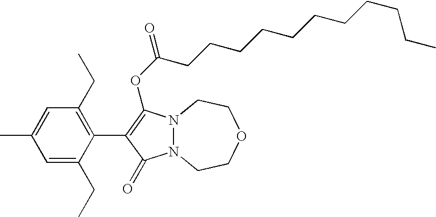

Triethylamine (1.0 ml, 7.17 mmol) and a spatula tip of 4-N,N-dimethylaminopyridine are added to a solution of 8-(2,6-diethylmethyl-phenyl)-tetrahydro-pyrazolo-[1,2-d][1,4,5]oxadiazepine-7,9-dione (2.00 g, 6.4 mmol) in 50 ml of tetrahydrofuran. Lauroyl chloride (1.7 ml, 7.16 mmol) is added dropwise at 20° C., with stirring. A white precipitate forms immediately. Thin-layer chromatography shows that the reaction is complete after 5 minutes. The reaction mixture is filtered under suction and the filtrate is concentrated by evaporation. The residue is slurried in hexane and a small amount of diethyl ether, is filtered with suction and is dried in vacuo. The crystalline substance thereby obtained has a melting point of 106-107° C. (MS (electron-spray): m/z=499 [M+H]⁺).

### Example P2

### Preparation of Compound 1.02

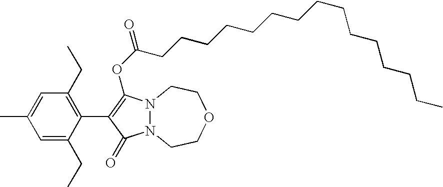

Triethylamine (1.4 ml, 10 mmol) and a spatula tip of 4-N,N-dimethylaminopyridine are added to a solution of 8-(2,6-diethyl-4-methyl-phenyl)-tetrahydro-pyrazolo-[1,2-d][1,4,5]oxadiazepine-7,9-dione (2.00 g, 6.4 mmol) in 50 ml of tetrahydrofuran. Palmitoyl chloride (2.2 ml, 7.24 mmol) is added dropwise at 22° C., with stirring. A white precipitate forms immediately. Thin-layer chromatography shows that the reaction is complete after 5 minutes. The reaction mixture is concentrated by evaporation and the residue is chromatographed on a short silica gel column using an ethyl acetate/hexane mixture. The product is slurried in pentane, filtered off under suction and dried in vacuo. The crystalline substance thereby obtained melts at 91-92° C. (MS (electron-spray): m/z=555 [M+H]⁺=).

### Example P3

### Preparation of compound 1.03

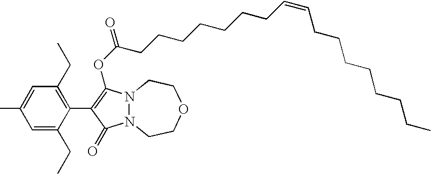

Triethylamine (1 ml, 7.1 mmol) and a spatula tip of 4-N,N-dimethylaminopyridine are added to a solution of 8-(2,6-diethyl-4-methyl-phenyl)-tetrahydro-pyrazolo-[1,2-d][1,4,5]oxadiazepine-7,9-dione (1.90 g, 6.0 mmol) in 40 ml of tetrahydrofuran. A solution of oleoyl chloride (7.0 mmol) (obtained from oleic acid under the action of oxalyl chloride) in 10 ml of tetrahydrofuran is added dropwise at 20° C., with stirring. A white precipitate forms immediately. Thin-layer chromatography shows that the reaction is complete after 10 minutes. The reaction mixture is filtered over a frit under suction and the residue is rinsed with tetrahydrofuran. The filtrate is concentrated by evaporation, and hexane (50 ml) is added to the residue. Small portions of diethyl ether are added until the product dissolves. The solution is partially concentrated by evaporation using a Rotavapor, without heating, a white suspension being formed. The suspension is centrifuged and the solution is removed. The solid is suspended in hexane and the solution is removed after centrifugation. After drying in vacuo, the desired product is obtained as a waxy solid having a melting point of 73-74° C.

### Example P4

### Preparation of Compound 1.04

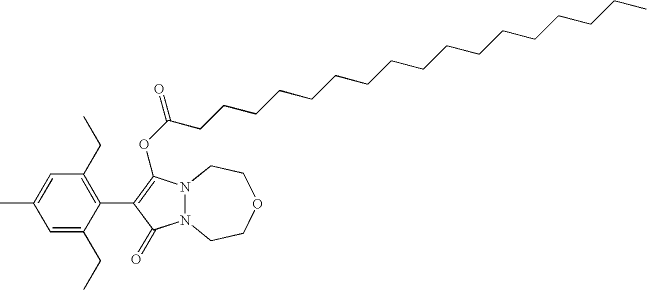

Stearoyl chloride (1.2 ml, 3.6 mmol), freshly distilled using a Kugelrohr oven, is added, at 20° C., to a solution of 8-(2,6-diethylmethyl-phenyl)-tetrahydropyrazolo[1,2-d][1,4,5]oxadiazepine-7,9-dione (1.00 g, 3.2 mmol), triethylamine (0.7 ml, 5.0 mmol) and a spatula tip of 4-N,N-dimethylaminopyridine in 30 ml of tetrahydrofuran. After stirring for 30 minutes, the reaction mixture is concentrated by evaporation, and the residue is dissolved in dichloromethane and rapidly chromatographed on a short silica gel column using an ethyl acetate/hexane mixture. The pure fractions are slurried in pentane and filtered under suction. The desired product is isolated as white crystals having a melting point of 32-33° C.

### Example P5

### Preparation of Compound 1.05a

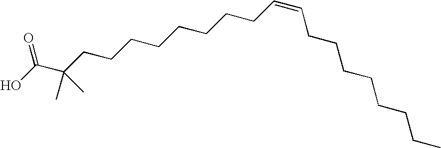

In an apparatus having a mechanical stirrer, N,N-diisopropylamine (0.464 g, 4.6 mmol) is added to a suspension of sodium hydride (0.20 g, 60% in oil, 4.95 mmol) in 15 ml of tetrahydrofuran. At 0° C., isobutyric acid (0.396 g, 4.5 mmol) is added. The reaction mixture is heated at 65° C. for 20 minutes and is then cooled to 0° C. and treated dropwise with n-butyllithium (1.6M in hexane, 2.81 ml, 4.5 mmol). The white suspension becomes a light-yellow solution. After 20 minutes, the temperature is increased to 30° C. and, after 15 minutes, lowered to 0° C. again. A solution of oleyl bromide (1.49 g, 4.5 mmol) in 4 ml of tetrahydrofuran is added. After 15 minutes, the temperature is increased to 30° C. One hour later, the batch is cooled again, water is added and the phases are separated. The organic phase is extracted with water/diethyl ether. The combined aqueous phases are extracted with diethyl ether, acidified using 2N hydrochloric acid and extracted again with diethyl ether. The final extract is shaken with brine, dried over sodium sulfate and concentrated by evaporation. The desired acid is obtained in the form of a colourless oil.

Spectroscopic Data:

¹H NMR (CDCl₃, 300 MHz): δ=5.40-5.30 (m, 2H, vinyl), 2.08-1.95 (m, 4H, allyl), 1.58-1.47 (m, 2H, CH₂ β to the carboxylic acid), 1.40-1.20 (m, 24H), 0.88 (t, 3H, methyl).

¹³C NMR (CDCl₃, 75 MHz): δ=185.0 (COOH), 130.3 and 130.2 (C═C).

MS (electron-spray): m/z=337 [M−H]⁻.
Preparation of Compound 1.05b

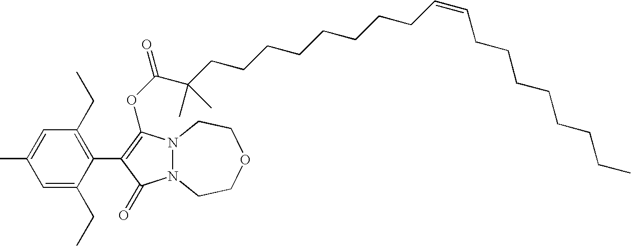

25 ml of a diethyl ether solution of the acid chloride prepared from cis-2,2-dimethylicos-11-enoic acid (21.38 mmol) and oxalyl chloride are added, at 20° C., to a solution of 8-(2,6-diethyl-4-methyl-phenyl)-tetrahydro-pyrazolo[1,2-d][1,4,5]oxadiazepine-7,9-dione (6.44 g, 20.36 mmol), triethylamine (5.2 ml, 37.31 mmol) and a spatula tip of 4-N,N-dimethylaminopyridine in 300 ml of tetrahydrofuran. After stirring for 30 minutes, the reaction mixture is filtered under suction and the residue is rinsed with diethyl ether. The filtrate is concentrated by evaporation and chromatographed (HPLC) on a silica gel column using a 25% ethyl acetate and 75% hexane mixture. The desired product is isolated as a yellowish oil.

Spectroscopic Data:

¹H NMR (CDCl₃, 300 MHz): δ=6.90 (s, 2H, aryl), 5.37 (m, 2H, vinyl), 4.28-4.23 (m, 2H), 3.95-3.89 (m, 2H), 3.88-3.78 (m, 4H), 2.60-2.35 (m, 4H, Ar—CH₂), 2.29 (s, 3H, Ar—CH₃), 2.08-1.97 (m, 4H, allyl).

MS (electron-spray): m/z=1274 [2M+H]⁺, 638 [M+H]⁺.

### Example P6

### Preparation of Compound 1.06a

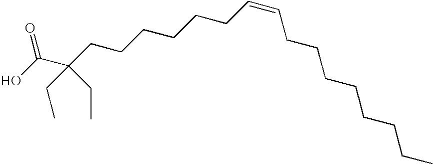

N,N-Diisopropylamine (1.11 g, 11.0 mmol) and then oleic acid (3.00 g, 10.6 mmol) are slowly added dropwise, at 0-5° C., to a suspension of sodium hydride (60% in oil, 0.47 g, 11.7 mmol) in 100 ml of tetrahydrofuran, with stirring. The reaction mixture is heated at 65° C. for 15 minutes. The suspension is cooled to 0° C. and n-butyllithium solution (1.6M in hexane, 10.0 ml, 16.0 mmol) is slowly added dropwise. After 15 minutes, the resulting yellow solution is heated at 35-40° C. for 30 minutes, is cooled again to 0° C., and is treated with ethyl bromide (1.74 g, 16.0 mmol) dissolved in 5 ml of tetrahydrofuran and is stirred overnight at 20° C. The white suspension is cooled again to 0° C., and a further portion of n-butyllithium solution (1.6M in hexane, 10.0 ml, 16.0 mmol) is added dropwise. The reaction mixture is heated at 35-40° C. for 30 minutes, is cooled again to 0° C. and is treated with ethyl bromide (1.74 g, 16.0 mmol) dissolved in 5 ml of tetrahydrofuran. Because the reaction is not complete (according to thin-layer chromatography), the successive addition of butyllithium solution and ethyl bromide is carried out a further two times using the same amounts and the same temperature schedule. When the reaction is complete, water is added to the reaction mixture and the phases are separated. The organic phase is extracted with water/diethyl ether. The combined aqueous phases are extracted with diethyl ether, acidified with 2N hydrochloric acid and again extracted with diethyl ether. The final extract is extracted by shaking with brine, dried over sodium sulfate and concentrated by evaporation. The desired acid is obtained in the form of a colourless oil.

Spectroscopic Data:

¹H NMR (CDCl₃, 300 MHz): δ=5.40-5.30 (m, 2H, vinyl), 2.1-1.9 (m, 4H, allyl), 1.7-1.5 (m, 6H, H β to the carboxylic acid), 1.4-1.1 (m, 20H), 1.0-0.75 (m, 9H, methyl). ¹³C NMR (CDCl₃, 75 MHz): δ=184.0 (COOH), 130.0 and 129.8 (C═C).

MS (electron-spray): m/z=337 [M−H]⁻.
Preparation of Compound 1.06b

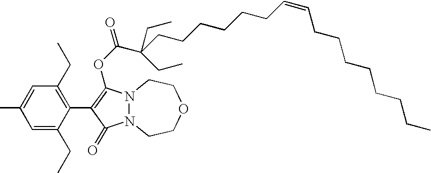

30 ml of a tetrahydrofuran solution of the acid chloride prepared from cis-2,2-diethyloctadec-9-enoic acid (5.91 mmol) and oxalyl chloride are added, at 20° C. to a solution of 8-(2,6-diethyl-4-methyl-phenyl)-tetrahydro-pyrazolo[1,2-d][1,4,5]oxadiazepine-7,9-dione (1.62 g, 5.12 mmol), triethylamine (0.83 ml, 5.94 mmol) and a spatula tip of 4-N,N-dimethylaminopyridine in 40 ml of tetrahydrofuran. After stirring for 30 minutes, the reaction mixture is filtered under suction and the residue is rinsed with diethyl ether. The filtrate is concentrated by evaporation using a Rotavapor, without heating, and is chromatographed on a short silica gel column using a gradient of from 10% ethyl acetate/90% hexane to 100% ethyl acetate. The desired product is isolated in the form of a yellowish oil.

Spectroscopic Data:

¹H NMR (CDCl₃, 300 MHz): δ=6.85 (s, 2H, aryl), 5.40-5.25 (m, 2H, vinyl), 2.6-2.3 (m, 4H, benzyl), 2.28 (s, 3H, benzyl).

MS (electron-spray): m/z=1274 [2M+H]⁺, 638 [M+H]⁺.

### Example P7

### Preparation of Compound 1.07

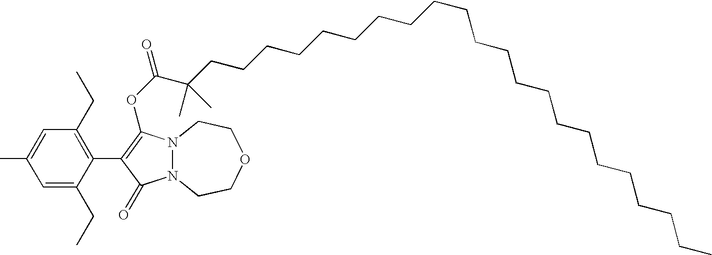

8-(2,6-Diethyl-4-methyl-phenyl)-tetrahydro-pyrazolo[1,2-d][1,4,5]oxadiazepine-7,9-dione (1.0 g, 0.00316 mol), 2,2-dimethyltetracosanoyl chloride (1.58 g, prepared from 2,2-dimethyltetracosanoic acid and thionyl chloride in toluene) and triethylamine (0.38 g, 0.0038 mmol) are mixed in 25 ml of acetonitrile and stirred at 20° C. for 20 hours. The reaction mixture is poured into 300 ml of dilute hydrochloric acid and is extracted twice with ethyl acetate. The organic phases are washed with brine, dried over sodium sulfate and concentrated by evaporation. The crude product is chromatographed on a silica gel column using an ethyl acetate/hexane mixture. The substance is isolated in the form of a crystalline material having a melting point of 80-82° C.

Spectroscopic Data:

¹H NMR (CDCl₃, 300 MHz): δ=6.90 (s, 2H, aryl), 4.30-4.20 (m, 2H), 3.99-3.92 (m, 2H), 3.90-3.82 (m, 4H), 2.61-2.37 (m, 4H, Ar—CH₂—CH₃), 2.29 (s, 3H, benzyl), 1.4-1.2 (m, 42H), 1.13 (t, J=13 Hz, 6H, Ar—CH₂-CH₃), 1.04 (s, 6H, α-methyl), 0.90 (t, J=12 Hz, 3H, methyl).

### Example P8

### Preparation of Compound 1.08a

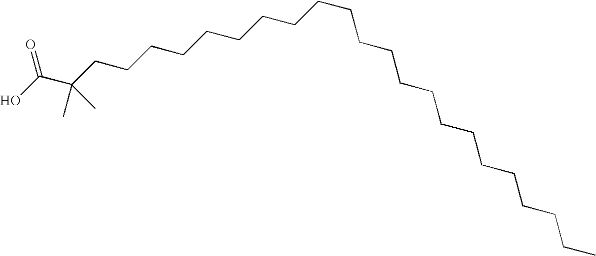

A solution of N,N-diisopropylamine (5.06 g, 0.05 mol) in 100 ml of tetrahydrofuran is cooled to −30° C. and n-butyllithium (1.6M in hexane, 30 ml, 0.048 mol) is so added that the temperature does not rise above −10° C. Isobutyric acid (2.02 g, 0.0229 mol) dissolved in 20 ml of tetrahydrofuran is added dropwise over the course of 15 minutes. The reaction mixture is then heated to 50° C. and, after 90 minutes, cooled to 20° C. A solution of 1-bromodocosane (9.74 g, 0.025 mol) in 20 ml of tetrahydrofuran is added dropwise. After stirring for 20 hours, 100 ml of saturated aqueous ammonium chloride solution and 8 ml of concentrated hydrochloric acid solution are added to the reaction mixture. The phases are separated, and the organic phase is extracted by shaking with brine, dried over sodium sulfate and concentrated by evaporation. The acid is re-crystallised from hexane.

### Example P9

### Preparation of Compound 1.09a

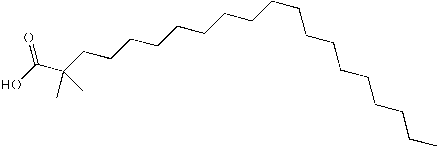

Isobutyric acid (4.65 ml, 50 mmol) is added, at 20° C., to a suspension of sodium hydride (60% in oil, 2.2 g, 55 mmol) in 70 ml of tetrahydrofuran and N,N-diisopropylamine (7.3 ml, 50 mmol). After heating to 65° C., the batch is cooled to 0° C., and n-butyllithium (2.0M in hexane, 25 ml, 50 mmol) is added dropwise. The resulting solution is heated at 40° C. for 30 minutes and is then cooled to 0° C. before 1-bromooctadecane (17.5 g, 52.5 mmol) in 40 ml of tetrahydrofuran is added. The reaction mixture is stirred at 35° C. for an hour and is then cooled and poured into an ice/water mixture; 2N sodium hydroxide solution is added. The suspension is filtered under suction and the residue is washed with 1N sodium hydroxide solution, water and hexane; it is then stirred into diethyl ether/4N hydrochloric acid. The phases are separated, the aqueous phase is extracted twice with diethyl ether and the combined organic phases are extracted by shaking with water and then with brine, dried over sodium sulfate and concentrated by evaporation.

Spectroscopic Data:

¹H NMR (CDCl₃, 300 MHz): 3=1.20 (s, 6H, α-methyl).

MS (electron-spray): m/z=339 [M−H]⁻, 385 [M+HCOO⁻].
Preparation of Compound 1.09b

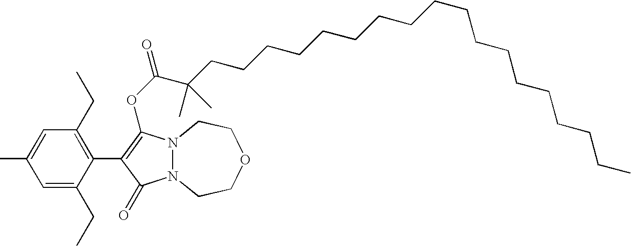

The procedure is analogous to Example P7 and the desired compound having the following spectroscopic data is obtained:

¹H NMR (CDCl₃, 300 MHz): δ=6.87 (s, 2H, aryl), 2.29 (s, 3H, aryl-CH₃), 1.12 (t, J=13 Hz, 6H, Ar—CH₂—CH₃), 1.05 (s, 6H, α-methyl); MS (electron-spray): m/z=640 [M+H]⁺.

### Example P10

### Preparation of Compound 1.10a

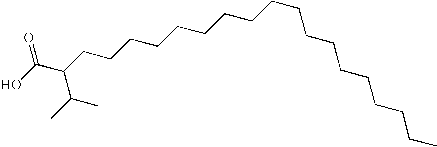

The procedure is as in Example P9a and the desired compound having the following spectroscopic data is obtained:

MS (electron-spray): m/z=353 [M−H]⁻, 399 [M+HCOO⁻].
Preparation of Compound 1.10b

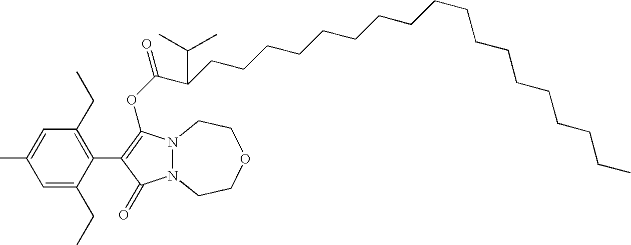

The procedure is as in Example P7 and the desired compound having the following spectroscopic data is obtained: MS (electron-spray): m/z=653 [M+H]⁺.

### Example P11

### Preparation of Compound 1.11a

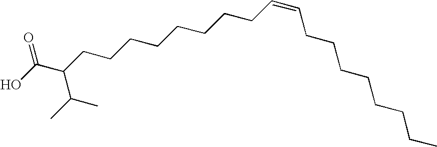

The procedure is as in Example P9a and the desired compound having the following spectroscopic data is obtained:

¹H NMR (CDCl₃, 300 MHz): δ=5.40-5.30 (m, 2H, olefin) . . . , 0.98 (d, 6H, isopropyl), 0.87 (t, 3H, methyl).

MS (electron-spray): m/z=351 [M−H]⁻, 397 [M+HCOO⁻].
Preparation of Compound 1.11b

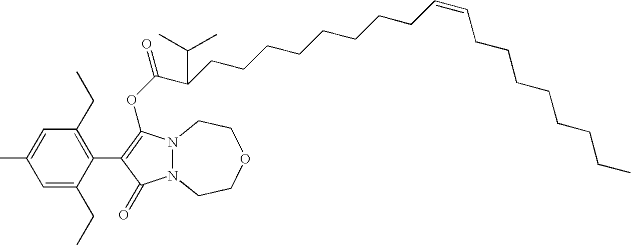

The procedure is as in Example P7 and the desired compound having the following spectroscopic data is obtained:

¹H NMR (CDCl₃, 300 MHz): δ=6.88 (s, 2H, aryl), 5.45-5.35 (m, 2H, olefin), 2.65-2.35 (m, 4H, aryl-CH₂—CH₃), 2.28 (s, 3H, aryl-CH₃),

MS (electron-spray): m/z=652 [M+H]⁺.

### Example P12

### Preparation of Compound 1.12

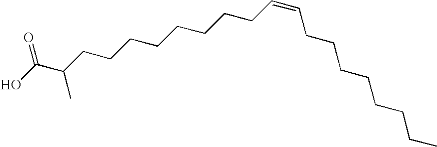

The procedure is as in Example P9a and the desired compound having the following spectroscopic data is obtained.

¹H NMR (CDCl₃, 300 MHz): B=5.40-5.30 (m, 2H, olefin), 2.46 (hexuplet, ₁H, α-H), 1.15 (d, 3H, α-methyl).
Preparation of Compound 1.12b

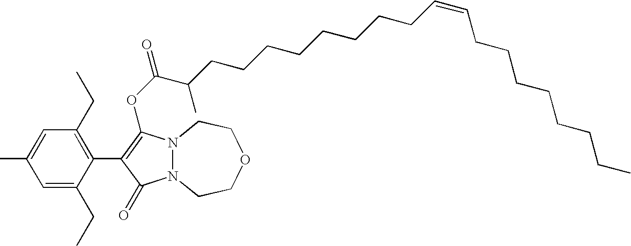

The procedure is as in Example P7 and the desired compound having the following spectroscopic data is obtained:

¹H NMR (CDCl₃, 300 MHz): δ=6.87 (s, 2H, aryl), 5.42-5.33 (m, 2H, olefin), 2.63-2.36 (m, 4H, aryl-CH₂—CH₃), 2.30 (s, 3H, aryl-CH₃), 1.01 (d, 3H, α-methyl), 0.90 (t, 3H, methyl); MS (electron-spray): m/z=623 [M+H]⁺.

### BIOLOGICAL EXAMPLES

Monocotyledonous and dicotyledonous weeds and summer wheat (Lona) are sown in standard soil in plastics pots. Directly after sowing, the test compounds are applied as EC 125 and WP 10 (without additional surface-active compounds). The rate of application is 125 g of active substance per ha. The test plants are then grown on in the greenhouse under optimum conditions. Evaluation is carried out 20 days after application: 100 denotes 100% damage to the plant in question.

Test plants: Agrostis (Agr), Alopecurus (Alo), Phalaris (Pha), Lolium (Lol) and Setaria (Set).

TABLE 21
Herbicidal action at rates of application of 125 g/ha

| | compound A | compound | compound 1.12b | compound 1.05b |
|---|---|---|---|---|
| | EC 125 | 1.03 WP 10 | WP 10 | WP 10 |
| wheat | 20 | 10 | 10 | 0 |
| Agr | 95 | 98 | 95 | 80 |
| Alo | 100 | 90 | 90 | 80 |
| Pha | 100 | 100 | 100 | 100 |
| Lol | 98 | 90 | 80 | 70 |
| Set | 100 | 100 | 90 | 70 |

Compound A is 8-(2,6-diethyl-4-methyl-phenyl)-tetrahydropyrazolo[1,2-d][1,4,5]oxadiazepine-7,9-dione.

Compared to compound A, the compounds according to the invention employed exhibit less phytotoxicity with respect to wheat whilst having approximately the same activity with respect to the weeds.

1. A compound of formula I 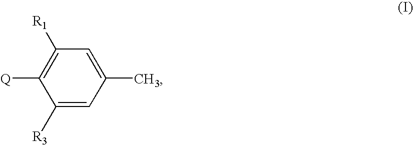
wherein
R₁ and R₃ are each independently of the other ethyl, haloethyl, ethynyl, C₁-C₂alkoxy, C₁-C₂haloalkoxy, C₁-C₂alkylcarbonyl, C₁-C₂hydroxyalkyl or C₁-C₂alkoxycarbonyl;
Q is a group 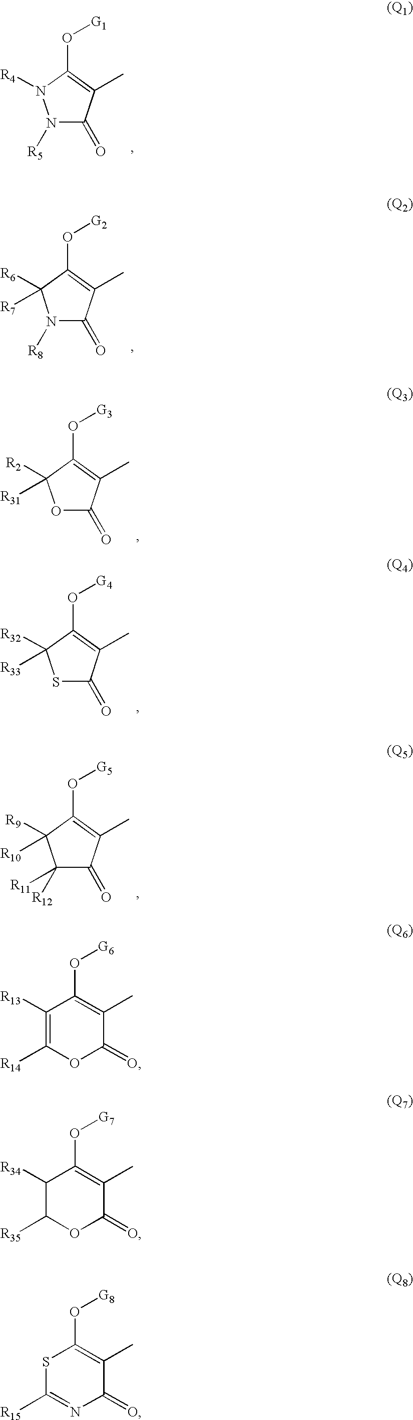 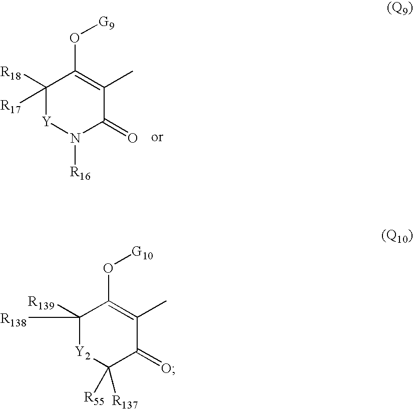
R₄ and R₅ are each independently of the other C₁-C₁₀alkyl, C₂-C₁₀alkenyl, C₂-C₁₀alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀-alkylthioalkyl, C₂-C₁₀alkylsulfinylalkyl, C₂-C₁₀alkylsulfonylalkyl, C₂-C₁₀alkylcarbonylalkyl, C₂-C₁₀-N-alkoxy-iminoalkyl, C₂-C₁₀alkoxycarbonylalkyl, C₁-C₁₀aminoalkyl, C₃-C₁₀dialkylaminoalkyl, C₂-C₁₀alkylaminoalkyl, C₁-C₁₀cyanoalkyl, C₄-C₁₀cycloalkylalkyl, C₁-C₁₀phenylalkyl, C₁-C₁₀heteroarylalkyl, C₁-C₁₀phenoxyalkyl, C₁-C₁₀heteroaryloxyalkyl, C₁-C₁₀alkylideneaminooxyalkyl, C₁-C₁₀nitroalkyl, C₁-C₁₀trialkylsilylalkyl, C₂-C₁₀alkylaminocarbonylalkyl, C₂-C₁₀dialkylaminocarbonylalkyl, C₂-C₁₀alkylaminocarbonyloxyalkyl, C₃-C₁₀dialkylaminocarbonyloxyalkyl, C₂-C₁₀alkoxycarbonylaminoalkyl, C₁-C₁₀-N-alkoxycarbonyl-N-alkylamino-alkyl, C₁-C₁₀cycloalkyl, aryl or heteroaryl; or
R₄ and R₅, together with the atoms to which they are bonded, form a 5- to 7-membered ring which may contain one or two hetero atoms selected from nitrogen, oxygen and sulfur and which may additionally contain a fused or spiro-linked alkylene or alkenylene chain consisting of from 2 to 6 carbon atoms which may in turn contain one or two hetero atoms selected from oxygen and sulfur, it being possible for that ring to be substituted by phenyl or by benzyl each of which may in turn be substituted by halogen, C₁-C₆alkyl, C₁-C₆haloalkyl, C₃-C₆cycloalkyl, hydroxy, C₁-C₆alkoxy, C₁-C₆alkoxy-C₁-C₆alkoxy, C₁-C₆haloalkoxy or by nitro;
R₂, R₆ and R₃₂ are each independently of the others C₁-C₁₀alkyl, C₂-C₁₀alkenyl, C₂-C₁₀alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C₂-C₁₀alkylsulfonylalkyl, C₂-C₁₀alkylcarbonylalkyl, C₃-C₁₀-cycloalkyl, aryl or heteroaryl;
R₇, R₃₁ and R₃₃ are each independently of the others hydrogen, C₁-C₁₀alkyl, C₂-C₁₀alkenyl, C₂-C₁₀alkynyl or C₂-C₁₀alkoxyalkyl;
R₈ is hydrogen, C₁-C₁₀alkyl, C₁-C₁₀haloalkyl, C₂-C₁₀alkoxyalkyl, C₃-C₁₀alkenyloxyalkyl, C₃-C₁₀-alkynyloxyalkyl, C₂-C₁₀alkylthioalkyl, C₂-C₁₀alkylsulfinylalkyl, C₂-C₁₀alkylsulfonylalkyl, C₃-C₁₀-cycloalkyl, aryl or heteroaryl; or
R₆ and R₇, or R₂ and R₃₁, or R₃₂ and R₃₃, together with the atom to which they are bonded, form a saturated, 3 to 7-membered ring which may contain one or two hetero atoms selected from nitrogen, oxygen and sulfur; or R₆ and R₈, together with the atoms to which they are bonded, form a 5- to 7-membered ring which may contain one or two hetero atoms selected from nitrogen, oxygen and sulfur;
R₉, R₁₀, R₁₁ and R₁₂ are each independently of the others C₁-C₁₀alkyl, C₂-C₁₀alkenyl, C₂-C₁₀-alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C₂-C₁₀alkylsulfonylalkyl, C₂-C₁₀alkylcarbonylalkyl, C₃-C₁₀cycloalkyl, aryl or heteroaryl; or
R₉ and R₁₁, or R₉ and R₁₀, together with the atoms to which they are bonded, form a 5- to 7-membered ring which may contain one or two hetero atoms selected from nitrogen, oxygen and sulfur;
R₁₃, R₁₄, R₃₄ and R₃₅ are each independently of the others C₁-C₁₀alkyl, C₂-C₁₀alkenyl, C₂-C₁₀-alkynyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C₂-C₁₀alkylsulfonylalkyl, C₂-C₁₀alkylcarbonylalkyl, C₃-C₁₀cycloalkyl, aryl or heteroaryl; or
R₁₃ and R₁₄, or R₃₄ and R₃₅, together with the atoms to which they are bonded, form a 5- to 7-membered ring which may contain one or two hetero atoms selected from nitrogen, oxygen and sulfur;
R₁₅ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₂-C₁₀alkylcarbonylalkyl, C₂-C₁₀alkoxycarbonylalkyl, C₁-C₁₀aminoalkyl, C₃-C₁₀dialkylaminoalkyl, C₂-C₁₀alkylaminoalkyl, C₁-C₁₀cyanoalkyl, C₄-C₁₀cycloalkylalkyl, C₁-C₁₀phenylalkyl, C₁-C₁₀heteroarylalkyl, C₁-C₁₀phenoxyalkyl, C₁-C₁₀heteroaryloxyalkyl, C₁-C₁₀nitroalkyl, C₃-C₁₀cycloalkyl, aryl or heteroaryl;
R₁₆ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₃-C₁₀cycloalkyl, aryl or heteroaryl;
R₁₇ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₂-C₁₀alkylcarbonylalkyl, C₃-C₁₀cycloalkyl, aryl or heteroaryl;
R₁₈ is hydrogen, C₂-C₁₀alkenyl, C₂-C₁₀alkynyl, C₁-C₁₀alkyl or C₁-C₁₀alkoxyalkyl; or
R₁₇ and R₁₈, together with the atoms to which they are bonded, form a 3 to 7-membered ring which may contain one or two hetero atoms selected from nitrogen, oxygen and sulfur;
Y is oxygen, sulfur, C—R₁₉ or N—R₃₆;
R₁₉ and R₃₆ are each independently of the other C₁-C₁₀alkyl, C₂-C₁₀alkenyl, C₂-C₁₀alkynyl, C₁-C₁₀haloalkyl, phenyl or heteroaryl; or
R₁₈ and R₁₉, or R₁₈ and R₃₆, together with the atom to which they are bonded, form a saturated, 5- to 7-membered ring which may contain one or two hetero atoms selected from nitrogen, oxygen and sulfur;
G₁, G₂, G₃, G₄, G₅, G₆, G₇, G₈, G₉ and G₁₀ are each independently of the others —C(X₁)—R₂₀, —C(X₂)—X₃—R₂₁, —C(X₄)—N(R₂₂)—R₂₃, —SO₂—R₂₄, —S(R₂₀₀)₃, —N(R₃₀₀)₄, —P(R₄₀D)₄, —P(X₅)(R₂₅)—R₂ or —CH₂—X₆—R₂₇;
X₁, X₂, X₃, X₄, X₅ and X₈ are each independently of the others oxygen or sulfur,
R₂₀, R₂₁, R₂₄, R₂₇, and at least one of the substituents R₂₀₀, at least one of the substituents R₃₀₀, at least one of the substituents R₄₀₀, at least one of the substituents R₂₂ and R₂₃ and at least one of the substituents R₂₅ and R₂₆ are each C₉-C₃₂alkyl, C₉-C₃₂alkyl substituted by one or more C₁-C₈alkyl groups, C₉-C₃₂alkenyl, or C₉-C₃₂alkenyl substituted by one or more C₁-C₈alkyl groups,
the remaining substituent or substituents R₂₀₀ is or are additionally C₁-C₈alkyl, C₃-C₈cycloalkyl, phenyl, or phenyl substituted by alkyl, halogen, alkoxy, thioalkyl, haloalkyl, haloalkoxy, haloalkylthio, cyano or by nitro, or two substituents R₂₀₀, together with the sulfur atom to which they are bonded, form a 5- to 8-membered ring which may be interrupted by an oxygen, nitrogen or sulfur atom,
the remaining substituent or substituents R₃₀₀ is or are as defined for R₂₀₀ with the additional possible meaning of hydrogen,
the remaining substituent or substituents R₄₀₀ is or are additionally C₁-C₈alkyl, phenyl, or phenyl substituted by alkyl, halogen, alkoxy, thioalkyl, haloalkyl, haloalkoxy, haloalkylthio, cyano or by nitro, or two substituents R₄₀₀, together with the phosphorus atom to which they are bonded, form a 5- to 8-membered ring which may be interrupted by an oxygen, nitrogen or sulfur atom,
R₂₂ and R₂₃ are additionally, each independently of the other, hydrogen, C₁-C₁₀alkyl, C₂-C₁₀alkenyl, C₂-C₁₀alkynyl, C₁-C₁₀haloalkyl, C₁-C₁₀cyanoalkyl, C₁-C₁₀nitroalkyl, C₁-C₁₀-aminoalkyl, C₁-C₅alkylamino-C₁-C₅alkyl, C₂-C₈dialkylamino-C₁-C₅alkyl, C₃-C₇cycloalkyl-C₁-C₅alkyl, C₂-C₁₀alkoxyalkyl, C₄-C₁₀alkenyloxyalkyl, C₄-C₁₀alkynyloxyalkyl, C₂-C₁₀alkylthioalkyl, C₁-C₅alkylsulfoxyl-C₁-C₅alkyl, C₁-C₅alkylsulfonyl-C₁-C₅alkyl, C₂-C₈alkylideneamino-oxy-C₁-C₅alkyl, C₁-C₅alkylcarbonyl-C₁-C₅alkyl, C₁-C₅alkoxycarbonyl-C₁-C₅alkyl, C₁-C₅aminocarbonyl-C₁-C₅alkyl, C₂-C₈dialkylaminocarbonyl-C₁-C₅alkyl, C₁-C₅alkylcarbonylamino-C₁-C₅-alkyl, C₁-C₅alkylcarbonyl(C₂-C₅alkyl)-aminoalkyl, C₃-C₆trialkylsilyl-C₁-C₅alkyl, phenyl-C₁-C₅alkyl, heteroaryl-C₁-C₅alkyl, phenoxy-C₁-C₅alkyl, heteroaryloxy-C₁-C₅alkyl, C₂-C₅alkenyl, C₂-C₅haloalkenyl, C₃-C₈cycloalkyl, phenyl, or phenyl substituted by C₁-C₃alkyl, C₁-C₃haloalkyl, C₁-C₃alkoxy, C₁-C₃haloalkoxy, halogen, cyano or by nitro, or heteroaryl or heteroarylamino, or heteroaryl or heteroarylamino substituted by C₁-C₃alkyl, C₁-C₃haloalkyl, C₁-C₃-alkoxy, C₁-C₃haloalkoxy, halogen, cyano or by nitro, diheteroarylamino, or diheteroarylamino substituted by C₁-C₃alkyl, C₁-C₃haloalkyl, C₁-C₃alkoxy, C₁-C₃haloalkoxy, halogen, cyano or by nitro, phenylamino, or phenylamino substituted by C₁-C₃alkyl, C₁-C₃haloalkyl, C₁-C₃alkoxy, C₁-C₃haloalkoxy, halogen, cyano or by nitro, diphenylamino, or diphenylamino substituted by C₁-C₃alkyl, C₁-C₃haloalkyl, C₁-C₃alkoxy, C₁-C₃haloalkoxy, halogen, cyano or by nitro, or C₃-C₇cycloalkylamino, di-C₃-C₇cyloalkylamino or C₃₋₄cycloalkoxy;
R₂₅ and R₂₆ are additionally hydrogen, C₁-C₁₀alkyl, C₂-C₁₀alkenyl, C₂-C₁₀alkynyl, C₁-C₁₀haloalkyl, C₁-C₁₀cyanoalkyl, C₁-C₁₀nitroalkyl, C₁-C₁₀aminoalkyl, C₁-C₅alkylamino-C₁-C₅alkyl, C₂-C₈-dialkylamino-C₁-C₅alkyl, C₃-C₇cycloalkyl-C₁-C₅alkyl, C₂-C₁₀alkoxyalkyl, C₄-C₁₀alkenyloxyalkyl, C₄-C₁₀alkynyloxyalkyl, C₂-C₁₀alkylthioalkyl, C₁-C₅alkylsulfoxyl-C₁-C₅alkyl, C₁-C₅alkylsulfonyl-C₁-C₅alkyl, C₂-C₈alkylideneamino-oxy-C₁-C₅alkyl, C₁-C₅alkylcarbonyl-C₁-C₅alkyl, C₁-C₅alkoxycarbonyl-C₁-C₅alkyl, C₁-C₅amino-carbonyl-C₁-C₅alkyl, C₂-C₈dialkylamino-carbonyl-C₁-C₅alkyl, C₁-C₅alkylcarbonylamino-C₁-C₅alkyl, C₁-C₅alkylcarbonyl-(C₂-C₅alkyl)-aminoalkyl, C₃-C₆trialkylsilyl-C₁-C₅alkyl, phenyl-C₁-C₅alkyl, heteroaryl-C₁-C₅alkyl, phenoxy-C₁-C₅alkyl, heteroaryloxy-C₁-C₅alkyl, C₂-C₅alkenyl, C₂-C₅haloalkenyl, C₃-C₈cycloalkyl, phenyl, or phenyl substituted by C₁-C₃alkyl, C₁-C₃haloalkyl, C₁-C₃alkoxy, C₁-C₃haloalkoxy, halogen, cyano or by nitro, or heteroaryl or heteroarylamino, or heteroaryl or heteroarylamino substituted by C₁-C₃alkyl, C₁-C₃haloalkyl, C₁-C₃lkoxy, C₁-C₃haloalkoxy, halogen, cyano or by nitro, diheteroarylamino, or diheteroarylamino substituted by C₁-C₃alkyl, C₁-C₃haloalkyl, C₁-C₃alkoxy, C₁-C₃haloalkoxy, halogen, cyano or by nitro, phenylamino, or phenylamino substituted by C₁-C₃alkyl, C₁-C₃haloalkyl, C₁-C₃alkoxy, C₁-C₃haloalkoxy, halogen, cyano or by nitro, diphenylamino, or diphenylamino substituted by C₁-C₃alkyl, C₁-C₃haloalkyl, C₁-C₃alkoxy, C₁-C₃haloalkoxy, halogen, cyano or by nitro, or C₃-C₇cycloalkylamino, di-C₃-C₇cycloalkylamino, C₃-C₇cycloalkoxy, C₁-C₁₀alkoxy, C₁-C₁₀haloalkoxy, C₁-C₅alkylamino, C₂-C₈-dialkylamino, benzyloxy or phenoxy, it being possible for the benzyl and phenyl groups in turn to be substituted by C₁-C₃alkyl, C₁-C₃haloalkyl, C₁-C₃alkoxy, C₁-C₃haloalkoxy, halogen, cyano or by nitro;
Y₂ is oxygen, sulfur, C—R₁₄₀-R₁₄₁ or N—R₁₄₂;
R₅₅ is C₁-C₁₀alkyl, C₂-C₁₀alkenyl, C₂-C₁₀alkynyl, C₁-C₁₀haloalkyl, C₂-C₁₀alkoxyalkyl, C₃-C₁₀-alkenyloxyalkyl, C₃-C₁₀alkynyloxyalkyl, C₂-C₁₀alkylthioalkyl, C₂-C₁₀alkylsulfinylalkyl, C₂-C₁₀-alkylsulfonylalkyl, C₂-C₁₀alkylcarbonylalkyl, C₃-C₁₀cycloalkyl, aryl or heteroaryl;
R₁₃₇ is hydrogen, C₁-C₁₀alkyl, C₂-C₁₀alkenyl, C₂-C₁₀alkynyl or C₁-C₁₀alkoxyalkyl; or
R₅₅ and R₁₃₇, together with the atoms to which they are bonded, form a 3- to 7-membered ring which may contain one or two hetero atoms selected from nitrogen, oxygen and sulfur;
R₁₃₈ and R₁₃₉ are each independently of the other hydrogen, C₁-C₁₀alkyl, C₂-C₁₀alkenyl, C₂-C₁₀alkynyl or C₂-C₁₀alkoxyalkyl, and
R₁₄₀ and R₁₄₁ are each independently of the other hydrogen, C₁-C₁₀alkyl, C₂-C₁₀alkenyl, C₂-C₁₀alkynyl or C₁-C₁₀alkoxyalkyl; or
R₅₅ and C—R₁₄₀, together with the atoms to which they are bonded, form a saturated or unsaturated, 3- to 7-membered ring which may contain one or two hetero atoms selected from nitrogen, oxygen and sulfur;
R₁₄₂ is hydrogen, C₁-C₁₀alkyl, C₁-C₁₀haloalkyl, C₂-C₁₀alkoxyalkyl, C₃-C₁₀alkenyloxyalkyl, C₃-C₁₀alkynyloxyalkyl, C₂-C₁₀alkylthioalkyl, C₂-C₁₀alkylsulfinylalkyl, C₂-C₁₀alkylsulfonylalkyl, C₃-C₁₀cycloalkyl, aryl or heteroaryl; or
R₅₅ and N—R₁₄₂, together with the atoms to which they are bonded, form a saturated or unsaturated, 3- to 7-membered ring which may contain one or two hetero atoms selected from nitrogen, oxygen und sulfur; or an agronomically acceptable salt, isomer or enantiomer of such a compound.

2. A compound according to claim 1, wherein Q is Q₁.

3. A compound according to claim 1, wherein R₂₀, R₂₁, R₂₄, R₂₇, and at least one of the substituents R₂₀₀, at least one of the substituents R₃₀₀, at least one of the substituents R₄₀₀, at least one of the substituents R₂₂ and R₂₃ and at least one of the substituents R₂₅ and R₂₆ are each unbranched C₉-C₂₅alkyl, unbranched C₉-C₂₅alkyl substituted in the α-position to the carbonyl group by one or more C₁-C₄alkyl groups, unbranched C₉-C₂₅alkenyl, or unbranched C₉-C₂₅alkenyl substituted in the e-position to the carbonyl group by one or more C₁-C₄alkyl groups.

4. A compound according to claim 3, wherein the alkenyl groups and C₁-C₄alkyl-substituted alkenyl groups have a single double bond in the cis configuration.

5. A process for the preparation of a compound of formula I according to claim 1, which comprises reacting a compound of formula II 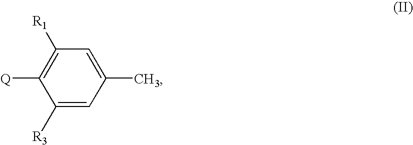
wherein R₁ and R₃ are as defined for formula 1, and Q is Q₁, Q₂, Q₃, Q₄, Q₅, Q₆, Q₇, Q₈, Q₉ or Q₁₀, wherein the substituents G₁, G₂, G₃, G₄, G₅, G₆, G₇, G₈, G₉ and G₁₀ are hydrogen, with a compound of formula III
Hal-G (III),
wherein Hal is chlorine, bromine or iodine, and G is —C(X₁)—R₂₀, —C(X₂)—X₃—R₂₁, —C(X₄)—N(R₂₂)—R₂₃, —SO₂—R₂₄, —S(R₂₀₀)₃, —N(R₃₀₀)₄, —P(R₄₀₀)₄, —P(X₅)(R₂₅)—R₂₆ or —CH₂—X₆—R₂₇, wherein X₁, X₂, X₃, X₄, X₅ and X₆ and R₂₀, R₂₁, R₂₂, R₂₃, R₂₄, R₂₀₀, R₃₀₀, R₄₀₀, R₂₅, R₂₆ and R₂₇ are as defined, in the presence of an inert solvent and a base.

6. A herbicidal and plant-growth-inhibiting composition which comprises, on an inert carrier, a herbicidally effective amount of a compound of formula I.

7. A herbicidal and plant-growth-inhibiting composition which comprises, on an inert carrier, a herbicidally effective amount of a compound of formula I and an amount, effective for herbicide antagonism, of a safener.

8. A herbicidal and plant-growth-inhibiting composition which comprises, on an inert carrier, a herbicidally effective amount of a compound of formula I and an amount, effective for synergism, of a co-herbicide.

9. A method of controlling undesired plant growth, which comprises applying a compound of formula I or a composition comprising such a compound, in a herbicidally effective amount, to the plants or to the locus thereof.

10. A method of inhibiting plant growth, which comprises applying a compound of formula I or a composition comprising such a compound, in a herbicidally effective amount, to the plants or to the locus thereof.
